(19) United States
(12) Patent Application Publication
(10) Pub. No.: US 2012/0117026 A1
(43) Pub. Date: May 10, 2012

(54) PLAY LIST MANAGEMENT

(75) Inventor: Brendon P. Cassidy, Los Angeles, CA (US)

(73) Assignee: Cricket Communications, Inc.

(21) Appl. No.: 13/158,319

(22) Filed: Jun. 10, 2011

Related U.S. Application Data
(60) Provisional application No. 61/353,606, filed on Jun. 10, 2010.
(60) Provisional application No. 61/394,209, filed on Oct. 18, 2010.
(60) Provisional application No. 61/394,222, filed on Oct. 18, 2010.
(60) Provisional application No. 61/425,192, filed on Dec. 20, 2010.
(60) Provisional application No. 61/430,016, filed on Jan. 5, 2011.

(51) Int. Cl. G06F 17/30

(52) U.S. Cl. 707/634; 707/E17.005

(57) ABSTRACT

Methods, systems, and apparatus are presented for accessing unlimited media service from a mobile communications device. In one aspect, a computer-implemented method of providing access to media content includes receiving a request from a mobile communications device associated with a user to subscribe to a media playlist. For the mobile communications device, a local media archive inventory is determined. The local media archive inventory is compared with a track listing corresponding to the subscribed media playlist; and contents of the local media archive inventory are modified based on the comparing.

This application claims priority under 35 U.S.C. §119(e) to Provisional Patent Application No. 61/353,606 entitled “Unlimited Media Access Over Wireless Infrastructure” filed Jun. 10, 2010, to Provisional Patent Application No. 61/394,209 entitled “Mobile Handset For Media Access And Playback filed Oct. 18, 2010, to Provisional Patent Application No. 61/394,222 entitled “Media Server Providing Unlimited Media Access Over Wireless Infrastructure” filed Oct. 18, 2010, and to Provisional Patent Application No. 61/430,016 entitled “Play List Management” filed Jan. 5, 2011, the contents of all four of which are incorporated herein by reference.

### BACKGROUND

This application relates to providing unlimited access to media, such as music and ring tones, to a mobile handset over wireless infrastructure, and to managing the unlimited access to media, local storage of accessed media, and local playback of media from the mobile handset.

Mobile communications devices have been adapted to a wide variety of applications, including computing, communication, and entertainment. For example, mobile communications devices permit users to freely initiate and receive voice communications, e.g. through dial-up connections or push-to-talk. Further, mobile communications devices have been developed to provide users with access to data communications through wireless connectivity, such as over Institute of Electrical and Electronic Engineers (IEEE) 802.11 or 3G/4G networks. Data communications can provide a user with access to a wide variety of entertainment options, including audio, video, and gaming content.

Services have been developed which permit a user to load media content, e.g. music and videos, onto a mobile communications device for subsequent playback. For instance, media content can be purchased from an on-line source, such as in accordance with a pay-per-song model. Purchased media content can be downloaded to a computing device, such a desktop or a laptop. Further, the content can be transferred off-line to from the computing device to a mobile communications device, e.g. through a sync (or synchronization) procedure. The media content can then be played back on the mobile communications device using a playback application. Once the media content is no longer desired on the mobile communications device, it can be deleted. If the media content is deleted, either purposefully or inadvertently, or if the mobile device is lost, the media content must be repurchased if it is once again desired. Accordingly, media device functionality, e.g. an MP3 player, can be incorporated into a mobile communications device.

Internet radio (or web radio or streaming radio) also has been developed to stream music over a network, such as the internet, to receivers that can play the streamed content. Internet radio typically is implemented similar to traditional broadcast radio in that the streamed content cannot be paused or replayed. Further, channels can be programmed to feature a particular style, type, or genre of content, but cannot be programmed by the listener. Additionally, the streamed content is not persistently stored on the receiver, so play back is possible only when a connection to the streaming source is available.

### SUMMARY

A mobile communications device (or “handset”) can be configured to operate in conjunction with a service structured to provide a subscriber with unlimited access to and/or unlimited use of media content. Unlimited access and/or unlimited use can be truly unlimited, such that no restrictions are placed on the amount of media that can be downloaded in a given period, e.g. a week or a month. Alternatively, unlimited access and/or unlimited use can be structured to impose one or more restrictions, such as a limitation on network traffic, e.g. measured in megabytes or gigabytes, over a given period, e.g. an hour or a day. The media content can include one or more of audio content (e.g. music), video content (e.g. television, movies, shorts), text-based content (e.g., e-books), and any combination thereof. Additionally, media content structured for use in communications, e.g. ring tones and ring back tones, also can be accessed by the mobile communications device.

Unlimited access to media content also can be provided in conjunction with one or more communications services, including one or more of voice communications, text communications, and data communications. The mobile communications device can be adapted to provide access both to the media content and to the communications services. For instance, the mobile communications device can be associated with a subscription to a single, unlimited-use offering that includes access to media content and one or more communications services.

The present inventors recognized a need to provide a mobile communications device configured to provide access to a local media archive and a remote media archive. The need to permit using the mobile communications device to select media, such as one or more songs, for download from the remote media archive to the local media archive also was recognized. Further, the present inventors recognized the need to permit adding one or more items of media to a play queue or a play list for local playback on the mobile communications device. The need to augment or revise a play queue or play list, including during playback, also was recognized. Additionally, the present inventors recognized the need to provide random playback from a local media archive, wherein media is selected for playback in accordance with one or more metrics associated with subscriber playback history.

The present inventors also recognized the need to permit switching the interface presented by the mobile communications device directly from a view of a media item included in the local media archive to a corresponding view of the media item in the remote media archive. Also, the need to perform digital rights management (DRM) at the storage media level for the local music archive was recognized. Further, the need to provide a secure, removable storage medium, e.g. a memory card, on which the local media archive can be stored also was recognized.

The techniques described in this specification can be implemented to realize one or more of the following advantages. The techniques can be implemented such that a mobile communications device can store locally an archive of media based on a subscription plan instead of a pay-per-download model. The techniques also can be implemented to permit authorizing a user to access media on the mobile communications device based on having an active subscription. Further, the techniques can be implemented to permit automatically altering one or more items of media stored on the mobile communications device based on one or more play lists. For instance, a play list can be altered periodically, e.g. weekly, and music included in the play list that is not presently stored on the mobile communications device can be automatically downloaded to the mobile communications device.

The details of one or more implementations are set forth in the accompanying drawings and the description below. Other features and advantages will be apparent from the description and drawings, and from the claims.

### BRIEF DESCRIPTION OF THE DRAWINGS

FIG. 1 shows an exemplary computing environment in which media can be transferred to a mobile communications device.

FIG. 2 shows an exemplary mobile communications device.

FIG. 3 shows an exemplary data flow between a mobile communications device, a computing device, and a server.

FIG. 4 shows an exemplary server configuration for providing unlimited access to media content.

FIG. 5 shows an exemplary configuration of modules included in the media server environment.

FIG. 6 shows exemplary media interfaces associated with a media application that can be presented by a mobile communications device.

FIG. 7 shows exemplary interfaces associated with playlist creation and management that can be presented by a mobile communications device.

FIG. 8 shows exemplary playlist management interfaces corresponding to a variety of functional areas.

FIG. 9 shows an exemplary process flow for playlist management.

FIGS. 10A and 10B show exemplary interfaces relating to playlist functionality in the media application.

FIG. 11 shows exemplary media application interfaces for receiving suggestions.

FIG. 12 shows exemplary interfaces associated with a setup wizard of the media application.

FIGS. 13A and 13B show exemplary media application interfaces for social interaction in the media application.

FIG. 14 shows an exemplary process flow for transferring media content to mobile communications device.

FIG. 15 shows an exemplary process flow for providing content corresponding to a subscribed play list.

FIG. 16 shows an exemplary process flow for recording information on a mobile communications device and reporting the information to the cloud.

FIG. 17 is a block diagram of an exemplary architecture of a data processing device, such as the communications device.

FIG. 18 is a block diagram of another computing device and system, such as servers.

Like reference symbols indicate like elements throughout the specification and drawings. Additional figures also are shown in the attached appendix.

### DETAILED DESCRIPTION

Techniques, apparatus, systems and non-transitory computer-readable media are described for providing unlimited access to items of media content, such as music and ring tones, to a mobile communications device over wireless infrastructure, and to managing the unlimited access to media, local storage of accessed media, and local playback of media from the mobile communications device. In one aspect, a playlist can be generated to provide a radio-station like listening experience. A playlist can be a local playlist, which is created by the subscriber from content in the local media archive. A playlist also can be a subscribed playlist, which is created and maintained by either an unlimited music system or another subscriber.

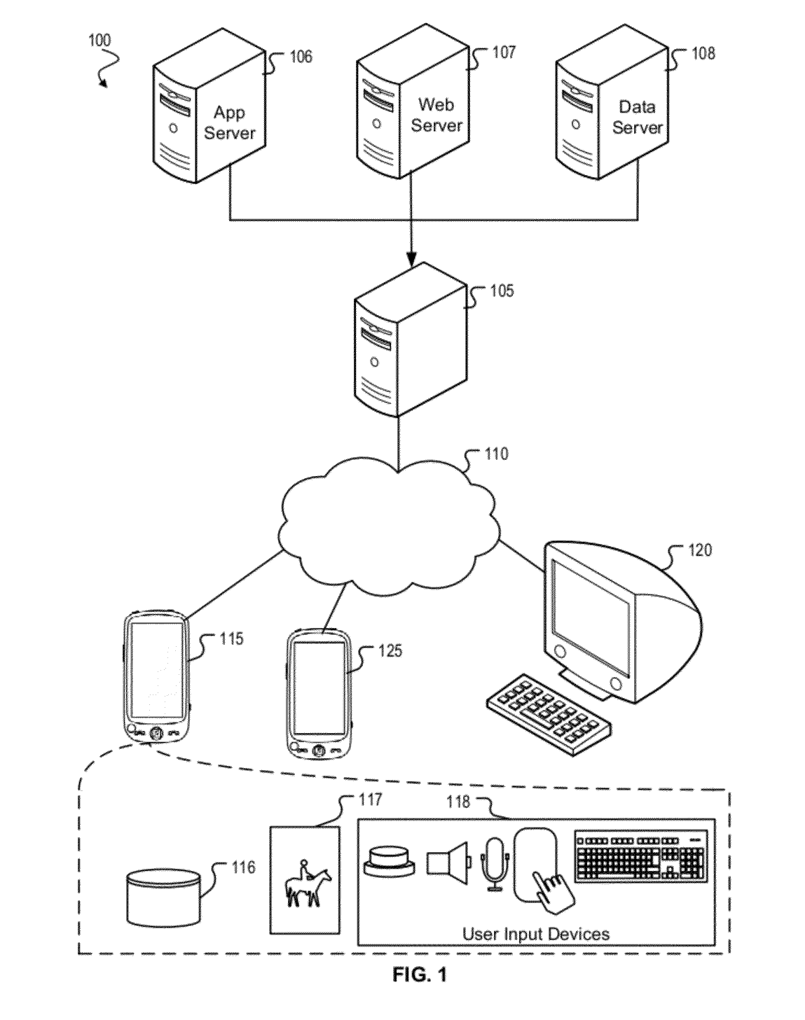

FIG. 1 shows an exemplary computing environment in which media can be transferred to a mobile communications device. Computing environment 100 can include a server 105 (or “the cloud”) configured to provide access to and management of media content. Server 105 can be implemented using a single computing device or multiple computing devices, which can be co-located or distributed across two or more locations. For instance, in some implementations, server 105 can be implemented using one or more application servers 106, web servers 107, and data servers 108, which can be housed in one or more locations.

Server 105 can host one or more applications configured to manage subscribing users. For instance, server 105 can be configured to validate a user or a mobile communications device before the user or the device is authorized to perform media related functions, including accessing locally stored media (on the communications device) and downloading media from server 105. Further, server 105 can maintain an instance of one or more user accounts, including user account details, e.g. mobile identification number and subscriber name, locally stored music, subscribed play lists, managed play lists, play back history, and contacts information. Server 105 also can host a media catalog (or media archive), which can be accessed by subscribing users or mobile communications devices to select items of media content for download to the mobile communications device. Additionally, server 105 can be configured to manage the transfer of media to one or more subscribing mobile communications devices, including the transfer of specifically requested media and the automated transfer of media associated with a subscribed collection, such as a play list.

Server 105 can be adapted to communicate with subscribing users over a network 110, which can be implemented using one or more data networks. For instance, network 110 can include either or both of wired and wireless communication links. Further, network 110 can be a public network, e.g. the internet, a private network, e.g. a cellular data network, or a combination thereof. Network 110 also can include one or more gateways, which facilitate the transfer of data between devices using different protocols. Further, network 110 can include either or both of secure links and unsecure links. Additionally, network 110 can include network infrastructure provided by multiple parties, such as a host network and one or more partner networks, e.g. roaming partners.

One or more mobile communications devices 115 associated with subscribing users also can be configured to communicate over network 110, e.g. with server 105 and with other mobile communications devices 125. In some implementations, the other mobile communications devices 125 need not be associated with other subscribing users. Any number of mobile communications devices 115 can be included in computing environment 100. As the number of mobile communications devices 115 increases, server 105 and network 110 can be scaled, e.g. by adding additional resources, to provide an acceptable level of service. A mobile communications device 115 can be any mobile device configured to communicate over the network 110 with a host service provider, e.g. server 105. For instance, a mobile communications device 115 can be a mobile telephone that is adapted to transmit and receive data communications, e.g., a smart phone, a personal digital assistant, a tablet computing device, a mini-computer, a micro-computer, a notebook computer, a laptop, or any other such computing device.

In addition to communicating with the server 105, a mobile communications device 115 can be configured to communicate wirelessly over a cellular network. For instance, the mobile communications device 115 can be associated with a subscription to an unlimited use communications plan that provides access to any or all of voice communications, text, and data communications. In some implementations, a subscription permitting unlimited access to media can be bundled with a communications plan for a single price, such as a communications plan that offers one or more unlimited communications services or a communications plan that provides a fixed amount of service, e.g. minutes or units of data, for a set fee. Moreover, any of the subscription plans can be implemented as a prepaid, partially prepaid, or post-paid plan.

A mobile communications device 115 further can include a data storage device 116 configured to receive and store media content. The data storage device 116 can be adapted to provide secure storage for the media content, as well as to perform digital rights management functions, e.g. decrypting media content for playback on the mobile communications device 115. In some implementations, the data storage device 116 can be a removable device, e.g. a flash memory module. Thus, a local media library can be stored across multiple data storage devices, which can be swapped to provide access to different portions of the library.

A mobile communications device 115 also can include a display 117, e.g. a liquid crystal display (LCD) or a light emitting diode (LED) display, and one or more user input devices 118, such as a touch screen (resistive or capacitive), a touch pad, one or more buttons, one or more keys, a scroll wheel, a dial, a switch, a microphone, or any other such input device. Further, a mobile communications device 115 can be adapted to communicate using one or more protocols, such as 3G, Wi-Fi, or other such protocols. For instance, a mobile communications device 115 can be configured to communicate over Wi-Fi when possible and otherwise to use a 3G connection.

Additionally, computing environment 100 can include one or more computing systems 120. A computing system 120 can be implemented using a computing device, such as a desktop computer, a laptop computer, a notebook computer, a net book, a tablet computing device, a workstation, and a server. Computing system 120 also can be configured to transmit and receive data over network 110, e.g. over a TCP/IP connection. Thus, computing system 120 can be adapted to provide data communications with server 105. For instance, computing system 120 can be used to perform functions relating to a subscribing user's account, such as account management and the selection of media.

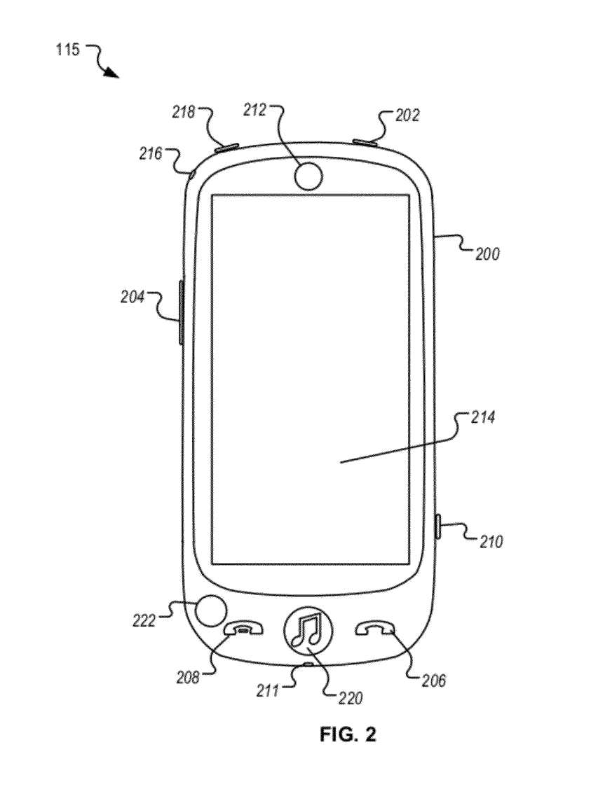

FIG. 2 shows an exemplary mobile communications device. Mobile communications device 200 can be configured to provide wireless voice communication and data communication. The device 200 can include physical controls, e.g. a power button 202, a volume control 204, a phone button 206, an end call button 208, and a camera button 210. Further, the device 200 can include inputs and outputs, such as microphone 211, speaker 212 and display 214, which can be a touch sensitive display, e.g. resistive or capacitive. Display 214 can be configured to sense either or both of simple gestures and complex gestures, such as multi-touch gestures. In some implementations, the device 200 also can include one or more additional speakers 216 configured to output additional audio output, such as voice and/or music. The one or more speakers can be located on any or all of the peripheral edges, the back, and the front of the device 200. One or more of the included speakers, e.g. the one or more speakers 216, can be used to implement audio playback and/or speakerphone functionality. An accessory jack 218, e.g. for headphones, also can be included. Further, the device 200 can have an integrated digital signal processor (DSP) that can provide for customized tuning of audio output. For example, the DSP can be adapted to provide a graphic equalizer, e.g. a five-band equalizer, to allow pinpoint sound control, and a dynamics processor to provide multi-band compression and limiting. One or more preconfigured options and one or more custom options can be used to specify the audio levels for each of the equalizer's bands. Compression can be configurable using predetermined levels, e.g. off, low, medium and high, which can correspond to software configured bundles of parameters for the compressor's various level, ratio, attack and decay parameters for each band. Also, one or more frequencies that cannot be reproduced by a given output device, e.g. the integrated speaker(s), can be rolled-off. Further, high-frequencies can be accentuated and the compressor can be switched into a mode to compensate for background noise. In some implementations, the DSP can be utilized for audio processing with respect to telephone communications, in addition to audio playback.

Additionally, the device 200 can include a media button 220, which can be used to access media functionality. In some implementations, the media button 220 can be a multi-function button. For instance, a single press of the media button 220 can toggle the display between a media playback interface and the phone interface. Further, pressing and holding the media button 220 can cause an interface corresponding to the media service, e.g. a home menu, to be presented. The device 200 can be configured such that accessing the media button 220 causes the corresponding media functionality to be presented, regardless of the previous function being performed and location within the device's command hierarchy. In some implementations, the functionality corresponding to media button 220 also can be state dependent. For instance, when media is playing, pressing the media button 220 can cause the music player interface to be displayed, while pressing and holding can cause the home screen of the remote media catalog (or store) to be displayed. The device 200 also can include physical controls for other functions, including volume and traversing back in the interface.

Also, in some implementations, a back button 222 can be included on the device 200. For implementations in which a back button 222 is included, the corresponding functionality can be removed from one or more interfaces presented on the device 200. For instance, one or more interfaces, e.g. associated with a media application, can include a virtual (or “soft”) command button or other such icon that can be selected to navigate backward within the interface hierarchy, such as to a preceding interface screen. When the back button 222 is included as a physical control on the device 200, it can be selected to perform the navigation function associated with the virtual command button, e.g. returning to a preceding interface screen, and the virtual command button can be removed to simplify the interface. In some other implementations, physical and virtual command buttons can be provided for one or more functions, including navigation.

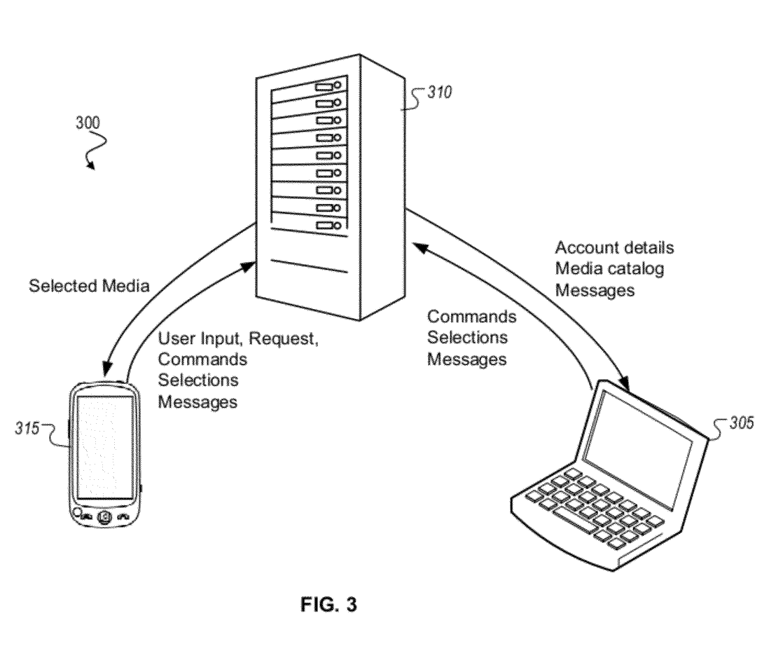

FIG. 3 shows an exemplary data flow between a mobile communications device, a computing device, and a server. Computing environment 300 can include a computing device 305, a server 310, and a mobile communications device 315. Computing device 305 can be implemented using any computer, including a desktop computer, a laptop computer, a net book, a tablet computer, a workstation, and a server. Further, server 310 can be implemented using one or more servers, e.g. as a combination of servers forming a virtual server, including one or more application servers, data servers, and web servers. Additionally, mobile communications device 315 can be any communication device configured to provide data communications, e.g. a smart phone or web-enabled phone.

Server 310 can communicate separately with both computing device 305 and mobile communications device 315. For instance, server 310 can communicate with computing device 305 over a public network, e.g. the internet, a private network, e.g. a local area network (LAN), or a combination thereof. Further, server 310 can communicate with mobile communications device 315 over a network that includes a wireless data network link, e.g. to a 3G or 4G network. Further, computing device 305 can communicate with mobile communications device 315 via a communications network, e.g., via a Wi-Fi or a 3G or 4G network. In some implementations, computing device 305 and mobile communications device 315 can be configured such that they do not communicate directly with each other.

Computing device 305 can communicate with server 310 to perform operations relating to one or more hosted media applications. For instance, computing device 305 can perform account management functions, messaging, and play list management. Server 310 can provide one or more interfaces to computing device 305. In some implementations, the one or more interfaces can be formatted for a larger display and thus can include additional information than corresponding interfaces provided to mobile communications device 315. Further, one or more of the interfaces provided to computing device 305 can be unique, such that they are not available for presentation to mobile communications device 315. Additionally, the one or more interfaces can be presented without installing an application or plug-in, e.g. as web pages presented in a browser. The interfaces can be compatible with multiple browsers, such that subscriber management from the computing device 305 can be platform independent.

The interfaces provided by server 310 can enable access to account details relating to a subscribing user, e.g. address and subscription information. Further, server 310 can provide access to at least a portion of a media collection or a central media archive, including one or more remote play lists (e.g., play lists that are not created and managed on a subscriber's mobile communications device). Items of media content can be selected from the media collection or central media archive for download to a mobile communications device 315. Also, play lists can be managed from the computing device 305, including generating play lists, modifying play lists, deleting play lists, subscribing to play lists and unsubscribing from play lists. Additionally, server 310 can provide access to one or more social services, including messaging associated with a media application. The social services can include the ability to read messages that have been received, the ability to generate new messages, and the ability to view and interact with one or more friends and neighbors.

Server 310 further can be configured to transfer media content selected through computing device 305 directly to mobile communications device 315. For instance, a user can browse the media collection provided by server 310 through an interface provided by computing device 305, and can select one or more items of media content, e.g. songs, for download. The items of media content selected for download can be transferred, e.g. through an over-the-air download, directly to mobile communications device 315. Further, one or more media items associated with a play list that was subscribed to through computing device 305 can be transferred directly to mobile communications device 315. As a result, mobile communications device 315 need not be synchronized with, or otherwise communicate with, computing device 305. Also, media content need not be downloaded to or stored on computing device 305. Thus, shared computing devices, e.g. library or school computers, can be used to perform account management and media management functions.

Additionally, an application can be downloaded to computing device 305 from server 310, which can be executed to identify media items stored on the computing device 305 that correspond to one or more identified media types. For instance, the application can be executed to scan one or more storage locations associated with computing device 305 and to identify files corresponding to one or more predetermined formats, such as MP3 or WAV. Further, metadata associated with media items identified at computing device 305 can be transferred back to the server 310. The transferred metadata can be analyzed by server 310 to determine whether it corresponds to one or more media items stored in the central media archive. In some implementations, any media items so identified from the central media archive can be automatically downloaded to the mobile communications device 315. In some other implementations, a list of media items included in the central media archive that match metadata transferred from the computing device 305 can be presented to a user, who can select any or all of the listed media items for transfer to the mobile communications device 315.

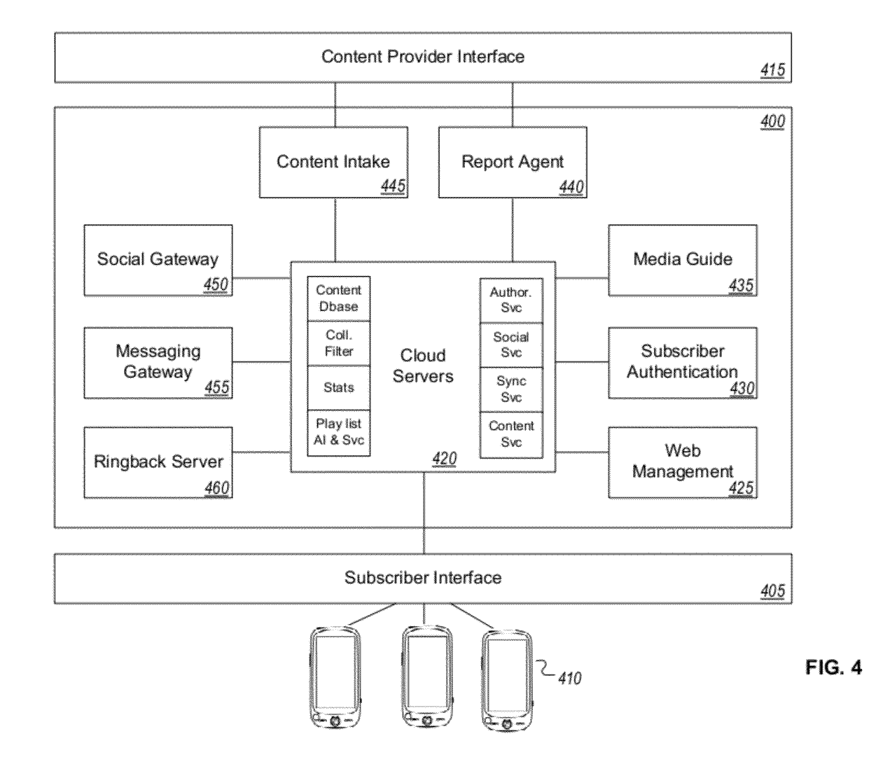

FIG. 4 shows an exemplary server configuration for providing unlimited access to media content. A media server environment 400 can be implemented using a collection of servers, e.g. configured to provide the appearance of a single device. The collection of servers can be scaled to correspond to demand. The collection of servers can include one or more core servers 420 (or “the cloud”) configured to provide services relating to the provision of media content. Additionally, the collection of servers can include one or more secondary servers, e.g. web management server 425, configured to provide additional functionality. In some other implementations, all of the functionality of media server environment 400 can be resident in the core servers 420. The servers included in media server environment 400 can be co-located or distributed, and can communicate over dedicated connections and/or networked connections, including public and private networks.

Media server environment 400 can be accessible to subscribers 410 through a subscriber interface 405, which can enable communication between one or more subscriber devices, e.g. mobile communications devices, and the collection of servers. For instance, subscriber interface 405 can include a gateway adapted to format communications transmitted and received by the media server environment 400. Media server environment 400 also can include a content provider interface 415 configured to provide access to one or more content providers. For instance, content provider interface 415 can permit media content providers, e.g. record label companies, to transfer media content into media server environment 400, such as through content intake server 445. Further, content provider interface 415 can permit content providers to receive reports, e.g. relating to media download activity, from media server environment 400. The subscriber interface 405 and content provider interface 415 also can be configured to provide security to control access to media server environment 400 and encryption/decryption of messages transmitted and received by the collection of servers. Additionally, a web management server 425 can be configured to provide user interfaces through which the functions provided by the media server environment 400 can be accessed.

Core servers 420 (or “Cloud” or “the Cloud”) can provide access to media content for subscribers 410. For instance, core servers 420 can include a content database (or central media archive) that includes the media content available for download by subscribers. The media content can include audio, such as music, ring tones, and ringback tones, and video, such as music videos, television programs, movies, and video shorts. Further, the media content can be encoded in one or more supported formats, such as when the media content is transferred into the media server environment 400. For instance, music can be encoded in a format that can support progressive playback, high-quality encoding, metadata support, robust error management, and compression, e.g. the Dolby (R) Pulse format. In some implementations, the media content can be received from a content provider in any format and converted to an internal format, e.g. Dolby (R) Pulse, by the content intake server 445.

The core servers 420 also can provide content related services. Browsing and searching functionality can be provided to permit subscribers to explore one or more portions of the media collection. For instance, a subscriber can search a music catalog based on one or more criteria, e.g. artist, album, song, or genre, or can browse a music catalog to select content. A media guide 435 can be configured to assist with browsing and searching functions, such as by identifying and classifying media included in the media catalog. Play list services also can be provided by the core servers 420. For instance, one or more preconfigured play lists, e.g. top 20 downloads, can be provided and maintained by the system. The play lists also can be automatically updated by the system, e.g. through the media guide 435. Subscribers to a play list can automatically receive as downloads all of the media, e.g. songs, included in the play list. In some implementations, only media from the playlist that is not already stored locally on the subscriber's device is downloaded. Further, as the play list is updated, e.g. by the playlist provider, the media downloaded to the playlist subscribers can be updated as well, such as by downloading to the subscriber devices media that is newly added to the play list. Also, media removed from the play list can be automatically deleted from the subscriber devices, e.g. if the media was not downloaded independently of the playlist or otherwise flagged for retention. Additionally, play list services also can be used to facilitate the creation of custom play lists by subscribers and to permit other subscribers to access the subscribers' custom play lists.

Downloading media to a subscriber device can be managed through synchronization services provided by the core servers 420. The synchronization is performed over-the-air between the core servers 420 and the subscriber's device, without connecting the subscriber's device to an additional computing device, e.g. a personal computer. An instance of each subscriber's account, which is intended to reflect the state at the corresponding subscriber's device, can be maintained by the core servers 420. The instance can include any and all information necessary to mirror the subscriber's mobile communications device configuration, including one or more of a unique track identification for each track stored in the local media archive, a unique playlist definition that describes the contents of each subscriber created playlist, a unique playlist identifier for each subscribed playlist, contact information, information describing account settings, information describing personalization settings, and configuration information. When the instance of a subscriber's account changes, e.g. when content is request for download or the content associated with a subscribed play list changes, the instance no longer reflects the state at the corresponding subscriber's device. This also is true in instances where the subscriber deletes or otherwise removes an item of media content from the local media archive stored on the subscriber device, or modifies account or personalization settings. When a difference exists between the state of the subscriber's instance at the cloud and the state of the subscriber's device, the synchronization services can be used to update the subscriber's device, e.g. with respect to downloaded media content. Through synchronization, the account instance maintained by the core servers 420 and the subscriber's device state can be returned to a matching state. For instance, media that has been added to a subscribed play list can be identified and delivered, e.g. through downloading, to one or more subscriber devices. Synchronization services also can be used to manage the download of media requested through the mobile communications device or the web interface. Further, synchronization can ensure that changes made to information such as account settings, configuration information, and personalization information is updated between the cloud and the local device. For instance, in response to a change in the personalization settings at the local device level indicating that content including explicit material should be hidden, a corresponding change can be implemented at the cloud level during synchronization.

Further, authorization services can be provided by the core servers 420, separately or in conjunction with a subscriber authentication server 430. For instance, a subscriber can be blocked from accessing media services, including downloading and playback, until the authorization services confirm that the subscriber's account is active. The subscriber authentication server 430 can be configured to maintain authentication information, such as account status, or to retrieve the authentication information from one or more other sources, e.g. billing systems or subscriber account databases. The subscriber also can be required to perform one or more verification and validation functions to confirm the subscriber's identity.

One or more statistics also can be generated by the core servers 420. The statistics can be associated with an individual subscriber, such as how frequently the subscriber plays a particular song or accesses a particular play list. The statistics also can be associated with multiple subscribers, such as how many times a song is downloaded. Further, the core servers 420 can communicate with a report agent 440 to generate statistics for one or more content providers.

Social services also can be provided by the core servers 420. The social services can be internal and/or external to the media system. For instance, internal social services can include introductions to other subscribers with similar tastes in media, the ability to review account information corresponding to other subscribers, e.g. friends and neighbors, and messaging with other subscribers, e.g. regarding media content. Further, links can be provided to one or more external social services through social gateway 450. For instance, a subscriber can interface with a social networking service, such as Facebook, MySpace, or Twitter, to provide information describing the subscriber's activities, such as identifying music to which the subscriber is currently listening. Additionally, a messaging gateway 455 also can be provided to facilitate messaging, e.g. through short message service (SMS) messages, between subscribers. In some implementations, messages also can be transmitted to one or more devices associated with users who are not subscribers.

Additionally, a ringback server 460 can be included in the media server environment 400. Ringback server 460 can store preconfigured ringback tones and ring tones that are accessible to subscribers. Further, ringback server 460 can be configured to permit users to generate custom ringback tones and ring tones based on media accessible through the core servers 420. For instance, a subscriber can select an item of music from the core servers 420 for download. The subscriber can then identify a portion of the selected item of music for use as a ringback tone or a ring tone, e.g. through specifying a beginning and end defining the portion to be used. Once generated, the ringback tone or ring tone can be stored locally at the subscriber's device. In some implementations, a separate ring tone server (not shown) can be included in the media server environment 400 instead of or in addition to the ringback server 460. The ring tone server can be configured to permit users to generate custom ring tones and/or to select preconfigured ring tones.

Collaborative filtering also can be provided by the core servers 420. The collaborative filtering can be used to automatically provide media recommendations to subscribers based on their previous interactions with the system, e.g. downloads, and/or the previous interactions with the system of one or more other users. Also, collaborative filtering can be used in conjunction with a recommendation service to facilitate music discovery. For instance, in response to a subscriber request, e.g. a one-click selection, the system can automatically provide (or push) one or more continually updating play lists to the subscriber's device. The content included in the one or more pushed play lists can be determined based at least in part on collaborative filtering. Further, the collaborative filtering can be used in conjunction with social services, e.g. introductions, such as to identify similarities between the media archive of a subscriber and those of one or more neighboring subscribers.

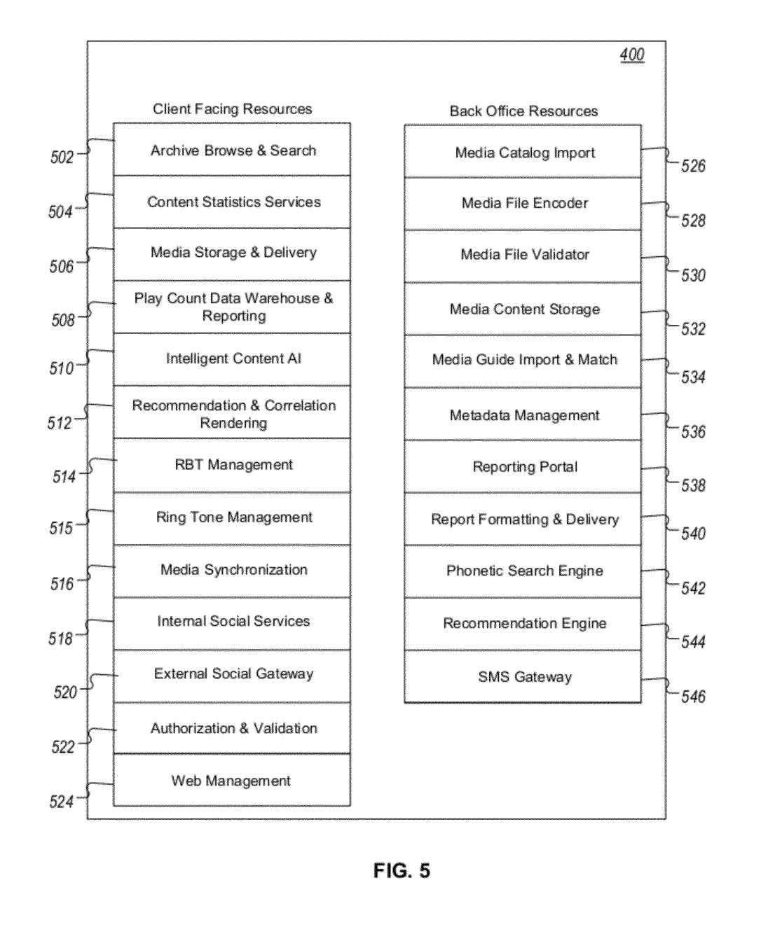

FIG. 5 shows an exemplary configuration of modules included in the media server environment. The media server environment 400 can incorporate multiple modules, which can be implemented in the various included servers. The modules can be client facing resources, which provide services that are accessible to subscribers, or back office facing resources, which provide support and management functionality. In some implementations, additional, fewer, or different modules can be included.

An archive browse and search module 502 can provide catalog browsing and searching services for one or more media catalogs accessible through the media server environment 400. The archive browse and search module 502 can present items available in one or more media catalogs through direct lookup, e.g. through artist, title, genre, or other classification, and by search, e.g. for media items that include a search term in a title. Further, the archive browse and search module 502 can provide multiple views for presenting requested information, e.g. album view and track view for a particular artist. For instance, a subscriber can request to view all tracks by U2 and can be presented with one or more pages that present the corresponding tracks. Further, the archive browse and search module 502, alone or in combination with one or more other modules, can render results in a predetermined format, e.g. XML, that can be transferred to a corresponding mobile communications device using compression, e.g. HTTP compression (HTTPC). Also, the results can be streamed to the mobile communications device, e.g. using a Simple API for XML (SAX) parser, to permit search results to be rendered progressively.

A content statistics services module 504 can be configured to expose statistics maintained by the media server environment 400 to subscriber or system requests. In some implementations, the content statistics services module 504 also can make statistics available to content providers. The statistics can be presented in a user requested format, such as one or more charts or rank-ordered listings. For instance, the statistics can be used to generate a chart of the most frequently accessed media over a period of time, such as the top 20 downloaded country songs over the last day. The statistics also can be used to generate subscriber specific charts relating to a particular user or group of users, which can be viewed by subscribers within the same group, e.g. community. Additionally, the content statistics services module 504 can communicate with other modules to retrieve information used to generate and to provide statistics used for other functions, such as report generation or subscriber preference analysis.

Media storage and delivery module 506 can be configured to provide subscribers with access to media content. Access can be restricted to authenticated users who have either a current or active subscription to service that includes media content. For instance, media storage and delivery module 506 can communicate with authorization and validation module 522 to confirm that a subscriber is permitted to access media content. Further, media storage and delivery module 506 can transfer requested media content to a mobile communications device using a secure connection, e.g. over-the-air transmission using an HTTPS connection. Additionally, delivery of media content can be performed by progressive download, e.g. using HTTP 1.1, such that media can be accessed before downloading has been completed and to permit downloading to be paused and resumed.

Play count data warehouse and reporting module 508 stores data indicating downloads and plays of media content items by individual subscribers. The data stored by play count data warehouse and reporting module 508 can be provided to one or more other modules, including content statistics services module 504, the reporting portal module 538, the report formatting and delivery module 540, and the recommendation engine module 544. Further, data relating to the instance of the subscriber's account, e.g. download history, also is maintained. Additionally, data corresponding to play counts and downloads can be recorded in real-time or near real-time, such that an accurate image of the system is persistently available.

An intelligent content Artificial Intelligence (AI) module 510 is configured to generate play lists. The AI module 510 can access data from other modules, including the content statistics services module 504, the recommendation and correlation rendering module 512, and the media synchronization module 516, to determine real-time or near real-time download and/or play back trends. Further, the AI module 510 can generate content for a play list for one or more categories of media content, e.g. genre or artist, based on the data received from other modules. The AI module 510 also can be configured to sequence the media content associated with a play list based on one or more criteria. For instance, media content can be arranged from highest to lowest relevance with respect to the play list in which it is included. Relevance can be determined based on one or more specified criteria, such as popularity rating and how recently the media content was added to the media collection. The media included in a play list also can be transferred to a requesting mobile communications device in accordance with the determined sequence, such that the most relevant media content is delivered first. Additionally, AI module 510 can be configured to support recommendation, e.g. “More Like This,” functionality. For instance, a subscriber can submit a request for media content similar to a unit of media content, which can range from a single item, e.g. a song, to an entire media collection. In response, the AI module 510 can return one or more personalized and content-specific recommendations.

The recommendation and correlation rendering module 512 can receive ratings data from a collaborative filter, which can correlate items of media content. The recommendation and correlation rendering module 512 also can provide recommendations and correlations to one or more other modules. Correlations can be generated for media content and for subscribers. For instance, the recommendation and correlation rendering module 512, in conjunction with the collaborative filter, can identify statistically related content, based on consumer taste, for an item or a collection of identified media content. Also, in response to receiving the identification of one or more subscribers, the recommendation and correlation rendering module 512 can generate a list of other subscribers who share common musical preferences. In some implementations, the list of other subscribers can be further limited, e.g. based on geographic location, third party ratings, MyCommunity ratings, ratings based on all subscribers, and/or ratings based on a subset of subscribers.

Ringback tone (RBT) management module 514 provides an interface with a corresponding ringback server on a communications network. A subscriber's ringback tones can be managed, including adding and deleting tones, from either or both of a mobile communications device and a web-based management platform through RBT management module 514. Subscriber ringback tone settings also can be configured through the module. Thus, a ringback tone acquired through the media server environment 400 can be configured for use through RBT management module 514.

A ring tone management module 415 also can provide an interface with a corresponding ring tone server on a communications network. A subscriber's ring tones can be managed, including adding and deleting ring tones, from either or both of a mobile communications device and a web-based management platform through the ring tone management module 415. Subscriber ring tone settings also can be configured through the module. Thus, a ring tone acquired through the media server environment 400 can be configured for use through the ring tone management module. In some implementations, the ring tone management module 515 and RBT management module 514 can be consolidated, e.g. in a single module.

Media synchronization module 516 can synchronize the media catalog stored locally on the mobile communications device with the instance of the subscriber's media catalog maintained at the media server environment 400. The media synchronization module 516 communicates with the mobile communications device to identify differences between the corresponding media catalogs and to identify a list of media content that is to be transferred to the mobile communications device. If multiple storage devices, e.g. memory cards, are used by the mobile communications device to store the local media catalog, the media synchronization module 516 can recognize the storage device presently in use. For example, a separate instance can exist at the media server environment 400 for each storage device. Further, the list can be prioritized based on one or more criteria, such as whether the media content was selected by the subscriber or is being provided based on a subscribed play list. Additionally, media synchronization module 516 can be adapted to maintain the metadata corresponding to a subscriber's account, including an indication of the items of media content, e.g. tracks, stored locally on the mobile communications device and an indication of the subscribed play lists.

An internal social services module 518 can manage the community interaction (or social interaction) that occurs in media server environment 400. For instance, a community can include one or more friends who the subscriber has expressly identified or who have been identified based on an existing connection with the subscriber, such as being included in the subscriber's contact list. In some implementations, the subscriber's contact list can be analyzed periodically, e.g. once a week, to identify contact's that have been newly added or who have recently subscribed and can now be listed as friends. The community also can include one or more neighbors identified by the media server environment 400. For instance, one or more neighbors can be identified based on proximity to the subscriber, e.g. including geography and correspondence of musical interests. In some implementations, geographical proximity and musical interests can be weighted to determine who should be identified as a neighbor. For example, a user who has almost identical musical interests to the subscriber can be identified as a neighbor even though they are separated by a large distance, as can a user who simply has more than a threshold amount of commonality with respect to music and is located very near the subscriber. The account details of friends and neighbors can be viewed through community interaction, including any or all of the downloaded media catalog, play history, ring tones, ring back tones, and play lists. Community interaction also can include sending and receiving of shouts (or messages) relating to media content.

Further, internal social services module 518 can perform or support media content related exploration, such as permitting a subscriber to compare their media collection with that of another user. For instance, a subscriber can compare the contents of their media archive with the contents of a friend or neighbor's archive to determine common media items, media items exclusive to the subscriber, and media items exclusive to the friend/neighbor. In some implementations, either or both of the common items and exclusives can be presented as reports, e.g. in response to the selection of a menu item. Further, a subscriber can create a virtual subscribed playlist based on the media items included in another subscriber's local archive. For instance, subscriber A can create a subscription to the local media archive of subscriber B. As a result, all of the media items unique to subscriber B's local media archive can be identified and ultimately downloaded into subscriber A's local media archive. As long as the subscription is maintained, any media item downloaded to subscriber B's archive that is not already stored in subscriber A's local media archive also will be automatically downloaded into subscriber A's local media archive.

Other exploration, including viewing another user's most frequently accessed media items or playback history also can be permitted. Additionally, internal social services module 518 can maintain a subscriber's social preferences and an indication of the subscriber's current geographical location, e.g. based on mobile communications device usage. This information can be used in the identification of neighbors and delivery of recommendations.

Social interaction provided through internal social services module 518 also can be extended through external social gateway 520. For instance, a subscriber can configure their account to direct shouts (or messages) they have generated to one or more external social services, such as Twitter and Facebook. A shout (or message) can include one or more links to content, such as a song or play list, and/or information. The external social gateway 520 permits communication with third-parties through published application program interfaces (APIs).

Authorization and validation module 522 provides authorization and validation services for subscribers seeking to access the media server environment 400. The authorization and validation module 522 can have a persistent connection to an account server, such that a subscriber's account status can be validated in real-time. If a subscriber's account is not current, e.g. has been suspended or closed, access to the media server environment 400 can be denied. Further, authorization and validation module 522 can continue to monitor a subscriber's account status while the subscriber is connected. If the subscriber's account lapses while the subscriber is connected, access can be terminated. The authorization and validation module 522 also can be adapted to inform a subscriber as to whether previously downloaded content should be accessible. Additionally, the authorization and validation module 522 can be configured to communicate with RBT management module 514 to enable and disable a subscriber's ringback tones and/or ring tones based on their account status.

Web management module 524 can be configured to support web-based management of a subscriber's account from any computer. Web-based browsing of the media catalog and content selection also can be provided, since content is transferred directly from media server environment 400 to the subscriber's mobile communications device. In some implementations, the web management module 524 can provide interfaces and functionality that mirror those provided through the mobile communications device. In some other implementations, one or more different interfaces can be provided, e.g. to utilize the expanded viewing area of a computer monitor, and one or more functions can be restricted or removed. Additionally, a downloadable widget can be provided in conjunction with web management module 524. The widget can be installed on any computing device, including any mobile computing device, and can be configured to scan one or more storage devices associated with the computing device to identify resident media content. Metadata identifying any discovered media content can then be provided back to web management module 524, so that the corresponding media content can be added to the subscriber's media catalog.

The back office resources can include a media catalog import module 526 that imports media and corresponding metadata from third-party partners, e.g. record label companies, into the media server environment 400. A change list can be generated in conjunction with each new file or set of files received from a third-party, e.g. so that the media catalog can be updated. The media catalog import module 526 also can be configured to validate each new file or set of files that have been received, and to flag any file that fails the validation. Additionally, either or both of the media content and corresponding metadata can be converted (normalized) into a format used within the media server environment 400. Media content that is received and validated can be stored in the media database and made available to subscribers.

A media file encoder module 528 can communicate with the media catalog import module 526, and can be adapted to encode some or all of the received media content, e.g. files that have not been pre-encoded, in a standard format. For instance, received music files that have not been pre-encoded in the standard format can be encoded in the High-Efficiency Advanced Audio Coding version 2 (HE-AACv2) format. The encoded HE-AACv2 files can employ features to improve quality and/or compression, including spectral band replication and parametric stereo. A media file validator module 530 also can communicate with the media catalog import module 526 to perform file validation. For instance, the media file validator module 530 can check each received file to verify that it is encoded in the proper format (using the proper codec) and at the proper bit rate. Further, the media file validator module 530 can check the number of channels and duration corresponding to the file. A file that is validated can be made available to subscribers as part of the media catalog. Alternatively, a file that fails validation for any reason can be flagged and kept separate from the media catalog. In some implementations, the media file validator module 530 also can include media recognition technology to validate that the file corresponds to the correct item of media, e.g. the song it is supposed to be.

Media content and storage module 532 can provide a virtual file system that spans multiple storage devices. The physical delivery of media content to requesting subscribers can be performed through media content and storage module 532. Further, the media content can be replicated at the file level in order to provide redundancy. By using multiple, physically independent storage devices and/or redundant files, requested files can be more quickly served to subscribers.

The media guide import and match module 534 matches metadata received from one or more media guides, e.g. the All Music Guide, with media content included in the media catalog. The received metadata can be linked with either or both of files and metadata from other sources stored in the media database. As a result, rich metadata associated with the media content can be provided to subscribers. For instance, the metadata included through the media guide import and match module 534 can include data to enrich presentation, such as album art and artist portraits. Additionally, the received metadata can be used to enhance recommendation functionality.

Metadata management module 536 provides a management interface that allows administrators to modify metadata associated with files, including overriding existing metadata and adding content details. Metadata can be overridden because administrator-supplied content details can be given precedence, upon publishing, over metadata supplied by third-parties. Further, metadata management module 436 provides the ability to manage media content for inclusion in system-generated play lists.

Reporting portal 538 can receive and/or extract statistics from other modules and system resources, and can provide the statistics for use by administrators and third-parties, e.g. content providers. Through reporting portal 538, reports can be specified, designed, and scheduled for delivery. Further, reports can be generated in real-time to reflect the current state of the system, including reports on subscriber actions, loading, scaling, and module performance. Reports, both scheduled and real-time, can provide granularity down to individual items of media content. Report formatting and delivery module 540 can receive reports generated by the reporting portal 538 and format them in accordance with requirements specified by third-parties. Once formatted, report formatting and delivery module 540 can deliver the reports to the appropriate third-parties. In some implementations, the reports also can be compressed prior to delivery.

Phonetic search engine 542 can be configured to process queries from subscribers. The queries can be submitted through either or both of a mobile communications device and a web-based computing device. In some implementations, the phonetic search engine also can provide support for non-subscriber facing functions, such as content matching and content import functions. A relational also-known-as (AKA) database can be included to provide matches for common misspellings and to provide a by-pass for previously matched items. The phonetic search and AKA database improve searching by providing results even when subscribers do not know the exact spelling and by overcoming typing errors, e.g. resulting from space-limited interfaces on mobile communications devices.

In performing a phonetic search, the received search phrase can be deconstructed and submitted to artificial intelligence reference analysis. The reference analysis can include one or more analysis tools, such as a phonetic index, a dictionary of common typographical errors, and an AKA dictionary. Further, the analysis also can reference either or both of a media content metadata store and an intelligent search cache. After the analysis has been performed, the search phrase can be reconstructed and the search results can be provided.

Recommendation engine 544 generates the data stored in the recommendation and correlation rendering module 512, which is periodically refreshed. The recommendation engine can generate data used for recommendations by aggregating and comparing data describing subscribers with data describing available content. In some implementations, the recommendation engine 544 can support the concepts of any or all of trust, Bayesian boosting, and temporal relevance, which can improve the relevance of recommendations for at least some content, e.g. music.

SMS gateway 546 processes all actions and communications that are to be provided to a subscriber in the form of an SMS message. The SMS gateway 546 can interface with a platform associated with the media server environment 400 or an SMS platform provided by a third-party.

These server functionalities can be used to provide various content related services including unlimited access to media content to a user and associated communications device. For example, a playlist can be generated to provide a radio-station like listening experience. A playlist can be a local playlist, which is created by the subscriber from content in the local media archive. A playlist also can be a subscribed playlist, which is created and maintained by either a home media interface (e.g., Unlimited Musik system) or another subscriber.

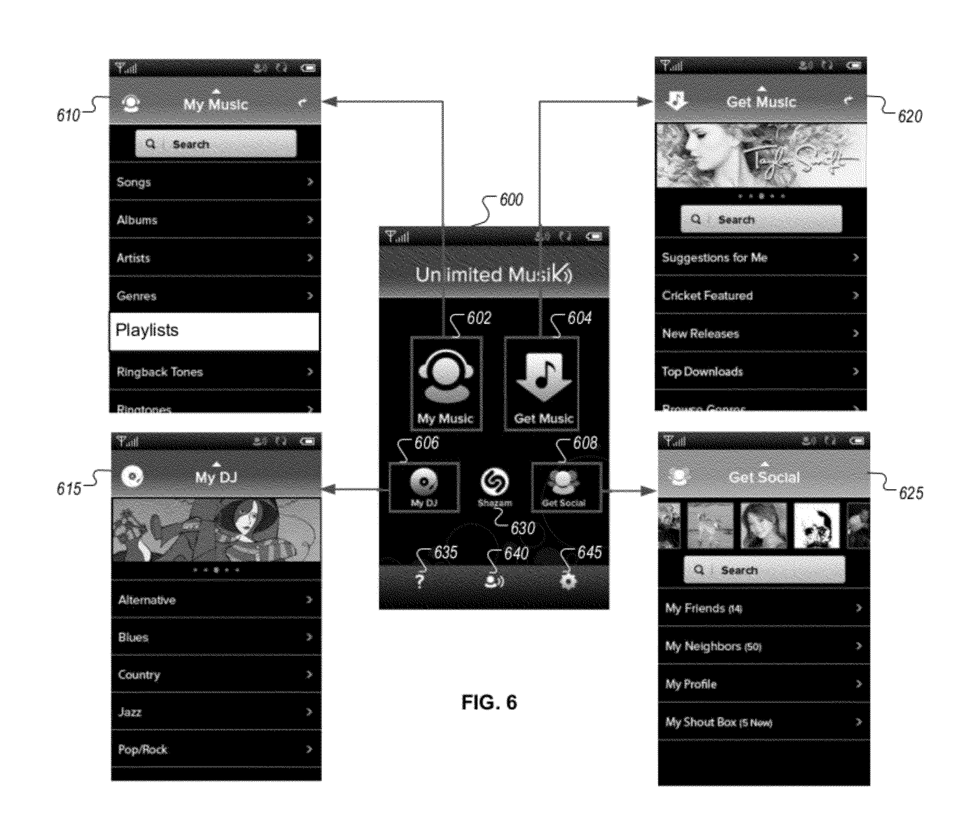

Playlist functionality can be invoked from any interface in which at least one item of media content is identified, e.g., by selecting a Playlist command button, icon or menu item. FIG. 6 shows exemplary media interfaces associated with a media application that can be presented by a mobile communications device. A home media interface 600 can be presented, which can provide access to functional areas within the media application as well as access to one or more utilities. The home media interface 600 can be the top-level interface for the media application. Home media interface 600 can include selectable icons corresponding to functional areas, including MyMusic icon 602, GetMusic icon 604, MyDJ icon 606, and GetSocial icon 608. An icon can be selected (or actuated) through any known technique, including through touch and cursor designation. The icons presented are representative and other implementations can include fewer, more, and/or different icons.

MyMusic icon (or button) 602 can be selected to present a local media interface 610, which can provide access to and browsing of the local media archive stored on the mobile communications device. The local media interface 610 can include categories by which the locally stored media can be sorted, including local playlists. Thus, a subscriber can maintain the local playlist using the local media interface. One or more other categories also can be included, such as songs, albums, artists, genres, ringtones, ringback tones, music videos, television shows, and movies. Selecting a category, such as the playlists from the local media interface 610 can present another interface, hierarchically organized as a sub-interface, that shows media corresponding to that category, allowing a user to traverse the local media archive. The local media interface 610 also can include a search tool, which can be used to search the local media archive, e.g. using keyword searching.

GetMusic icon 604 can be selected to present a remote media interface 620, corresponding to a remote music archive or media store. The remote media interface 620 can provide access to and browsing of the remote media archive and can be configured to include categories by which the media is organized. For instance, the remote media interface 620 can include one or more categories corresponding to the local media interface 610 including playlists, songs, albums, artists, genres, ringtones, and ringback. The remote media interface 620 also can include one or more other categories, including personalized suggestions, featured media, new releases, and top downloads, e.g. for a predetermined period of time, such as a day, week, or month. Selecting a category from the remote media interface 620 can present another interface, hierarchically organized as a sub-interface, that shows media corresponding to the selected category, allowing a using to traverse the remote media archive. The remote media interface 620 also can include a search tool, which can be used to search the remote media archive, e.g. using keyword searching.

The content of a subscribed playlist can be remotely managed by the server using the home media interface 600. The home media interface 600 automatically maintains the subscribed playlist, and when the content of the subscribed playlist is modified, one or more media content items can be automatically transferred to and/or deleted from the subscriber's local media archive, such that all media content items associated with the subscribed playlist are stored and updated in the subscriber's local media archive. Further, the subscriber's instance at the Cloud (e.g., server 105) can be accessed in response to a detected change in a subscribed playlist to determine whether media content items newly added to the subscribed playlist already is locally available at the subscriber's local media archive. When detected that any of the media content items in the subscriber's playlist is not locally available, the missing media content items can be automatically transferred to the subscriber's mobile communications device.

The subscriber's mobile communications device can communicate with the home media interface 600 at the Cloud (e.g., server 105) using data synchronization operations to effectuate any changes to the subscriber's playlist and update the subscriber's local media archive. A subscriber's local media archive can be updated any time based on detected changes to a subscribed playlist. For instance, when the subscribed playlist is not accessed prior to the next synchronization operation, updates responsive to the changes can be performed during synchronization. Further, when the subscribed playlist is accessed prior to synchronization, one or more items of media content can be transferred to the subscriber's mobile communications device in real-time, as needed by playback of the play list. Additionally, the frequency with which a local media archive is updated to reflect changes to a subscribed playlist can be varied based on the frequency with which the playlist is accessed by the subscriber. Thus, local media content can be infrequently updated for a playlist that is infrequently accessed by the subscriber, even if the playlist is modified more frequently.

A subscribed playlist maintained by the home media interface 600 can be converted to a local playlist manually maintained by the subscriber at the subscriber's mobile communications device. For instance, a subscriber can indicate that the subscriber would like to take over maintenance of a subscribed playlist, so that the subscriber can assume management responsibility for the subscriber's local copy. As a result, the connection to the sever-side maintainer (e.g., home media interface) is broken and the subscribed playlist is converted to a local playlist copy that can be altered only by the subscriber using the local media interface 610.

MyDJ icon 606 can be selected to present a playlist interface 615, which can provide access to and browsing of the playlists available to the mobile communications device. The playlists can include either or both of local playlists, e.g. generated by the user of the device, and remote playlists that are generated by an external provider, such as another user or the system operator. A subscriber can expose their local playlists so that other music system subscribers can subscribe to them. Any subsequent changes to such a local playlist can cause the local media archives of any subscribers to be modified in kind. The playlist interface 615 can include categories by which the playlists can be sorted, such as genre, content, and playlist source. For instance, the playlists can be organized using genres such as alternative, blues, country, jazz, and pop/rock. Selecting a category from the playlist interface 615 can present another interface, hierarchically organized as a sub-interface, that shows playlists corresponding to that category. In some implementations, the playlists shown can include playlists that are presently available, e.g. local playlists and subscribed playlists, and playlists that are not presently available but can be subscribed to. Further, the playlists that are presently available can be visually distinguished from those that are not, such as through highlighting or through the association of a graphical identifier.

GetSocial icon 608 can be selected to present a social interface 625, which can provide access to the subscriber's community. The community can include connected friends who also are subscribers to the media service, identified neighbors, and a Shout box that provides access to messaging within the media application and service. Further, the social interface 625 can provide access to the subscriber's profile, which can be used to describe and publicize subscriber characteristics, including musical preferences and the subscriber's local media archive. The social interface 625 also can include a search tool, which can be used to search the subscriber's social connections, e.g. using keyword searching.

Additionally, home media interface 600 can present one or more utility icons, which can be accessed to perform operations corresponding to the media application. For instance, a music recognition icon 630 can be selected to capture audio and submit it to a music recognition service. Also, a help icon 635 can be selected to access help, e.g. instructions or demonstrations, relating to one or more features and functions of the media application. A help interface organized by topics, such as functions, can be presented in response to selection of the help icon 635. In some implementations, a full tutorial for the media application also can be accessed.

A Shout icon 640 can be selected to access a Shout interface presenting the subscriber's Shout message box. The Shout message box can include Shout messages to and between all members of the subscriber's community. Further, the Shout interface can include an option to view only Shouts addressed to the subscriber and/or sent by the subscriber. Additionally, the home media interface 600 can include a settings icon 645, which can be selected to view and alter one or more media application settings, including synchronization status settings, social settings, card settings, and parental controls.

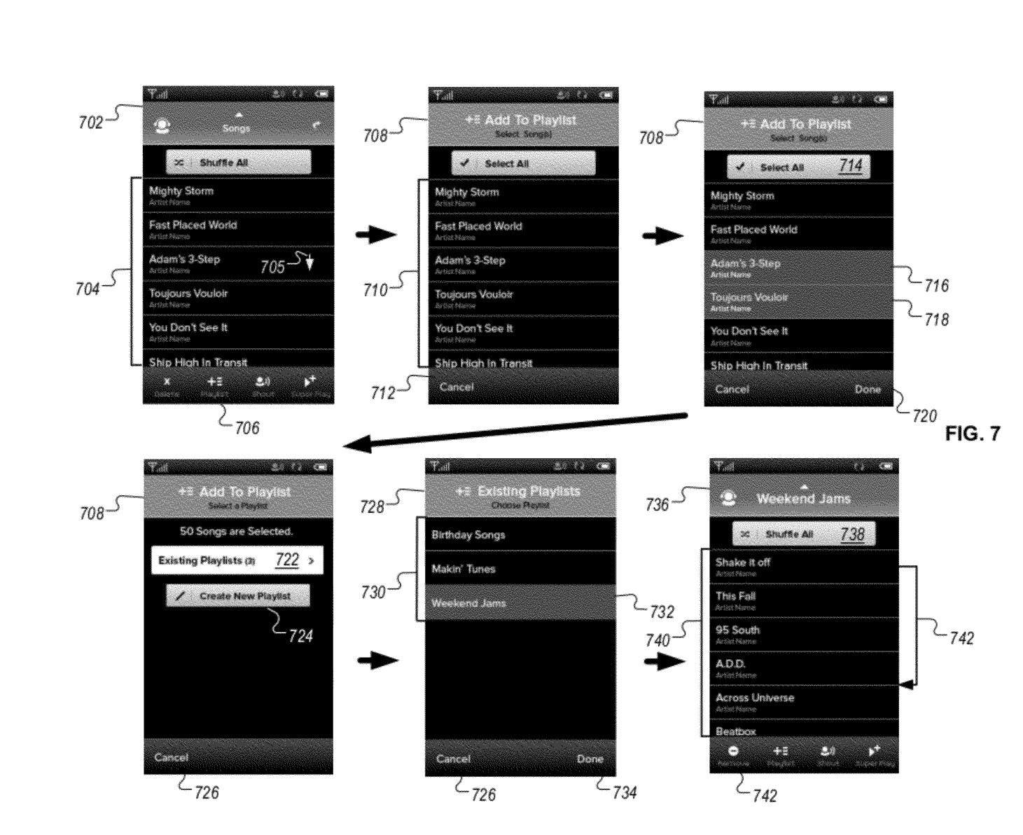

FIG. 7 shows exemplary media application interfaces associated with playlist management that can be presented by a mobile communications device. The media application can be configured to generate, maintain, and/or access playlists, each of which can reference one or more items of media. A local playlist can be generated by a subscriber based on items of media content stored in the local media archive. The subscriber also is free to modify or delete the local playlist at any time. Further, one or more remote playlists, which are created and maintained by an entity other than the subscriber, also can be subscribed to. Once a subscription to a remote playlist has been established, the media content corresponding to that playlist can be downloaded to the local media archive. In some implementations, the remote playlist can be compared with the local media archive and only media content that is not already stored in the local media archive is identified for downloading. As long as the subscription to the remote playlist is active, the local media archive can be automatically updated to reflect changes to the remote playlist, e.g. an item of media content can be automatically added to the local media archive in response to the addition of that item of media content to the remote playlist. Additionally, a subscriber can save a copy of the remote playlist as a local playlist, which can then be modified in accordance with the subscriber's preferences.

The media application can be configured to permit creating a local playlist from one or more of the functional areas, such as the MyMusic, GetMusic, MyDJ, and GetSocial functional areas. Playlist generation can be initiated by selecting a playlist icon or command button presented in an interface. The interface can correspond to local content, i.e., one or more songs already stored in the local media archive, or remote content, such as a listing of one or more songs associated with the media store or the local media archive of another subscriber. For instance, a songs interface 702 corresponding to an album for which one or more tracks are stored in the local media archive can be presented. The songs interface 702 can include a track listing 704 identifying all of the tracks included on that album or all of the tracks stored in the local media archive. The track listing 704 can be scrollable and/or resizable if the number of tracks exceeds the amount of available display space in the interface. If all names are included, the names of tracks that are stored in the local media archive, e.g. in MyMusic, can be visually distinguished from the names of the remaining tracks, such as through highlighting, text color, shading, or the presentation of a graphical device. Further, a download indicator 705 can be presented in association with a track in the track listing 704 that is in the process of being downloaded. Additionally, the songs interface 702 can feature one or more user selectable command buttons, e.g. at the bottom of the interface, including a playlist button 706.

A playlist interface 708 can be presented in response to selection of the playlist button 706. The playlist interface 708 can include a track listing 710, which corresponds to the track listing 704 of the songs interface 702 from which the playlist button 706 was selected. Further, the playlist interface 708 can include a cancel button 712, which can be selected to exit the playlist function without making any changes.

One or more tracks can be selected from the track listing 710. For instance, a select all button 714 can be included to select each of the tracks in the track listing. Also, one or more tracks can be selected or deselected individually, e.g. by touching the track name in the track listing 710. For instance, the tracks Adam's 3-Step 716 and Toujours Vouloir 718 can be individually selected from the track listing 710. If a track has not been selected, actuating the corresponding track listing, e.g. in a touch-interface, causes the track to be selected. Conversely, if a track has been selected, actuating the corresponding track listing causes the track to be deselected. The select all button 714 and individual selection/deselection also can be used in conjunction, e.g. to select all displayed tracks and then to deselect one or more individual tracks.

A track that has been selected can be visually identified in the track listing 710, e.g. by highlighting the track entry or by altering either or both of the text color and the background color. For instance, the selected tracks Adam's 3-Step 716 and Toujours Vouloir 718 can be presented using a different background color to distinguish them from the remaining tracks that have not been selected. Additionally, a done button 720 also can be presented in the playlist interface 708, e.g. upon selection of the first track, to indicate that track selection is complete.

Upon selection of the done button 720, one or more command options can be presented in the playlist interface 708, such as an existing playlist button 722 and a create new playlist button 724. The existing playlist button 722 also can indicate the number of existing playlists. Selecting the create new playlist button 724 can cause a new playlist to be generated, which includes each of the presently selected tracks. Also, a user interface or command tool can be presented to permit the subscriber to name the newly created playlist. Alternatively, selecting the existing playlist button 722 can cause an existing playlist interface 728 to be presented. The existing playlist interface 728 can include a playlist listing 730 that identifies each of the local playlists available to the mobile communications device. A local playlist can be selected from the playlist listing 730, such as by touching the local playlist name or by designating it with a cursor. In some implementations, selecting a local playlist name, e.g. Weekend Jams 732, can cause a corresponding local playlist interface to be presented. In some other implementations, a done button 734 can be selected to finalize the selection.

The tracks selected through the playlist interface 708 can be added to the local playlist selected from the playlist listing 730, e.g. Weekend Jams 732. Further, a corresponding local playlist interface 736 can be presented for the selected playlist, e.g. Weekend Jams 732, to show the associated track listing 740. Additionally, the sequence of the associated tracks can be edited in the local playlist interface 736. For instance, a shuffle all button 738 can be selected to reorder all of the associated tracks, e.g. randomly. An individual track also can be repositioned within the track listing 740, such as by a drag-and-drop operation 742. Also, a remove button 744 included in the local playlist interface 736 can be selected to remove one or more selected tracks. In some implementations, the subscriber can be prompted to save the edited playlist after one or more tracks have been removed or the playlist has been reordered.

Also, a download operation can be initiated for each media item, e.g. track, added to a playlist of which a copy is not stored in the local media archive. The download operation can be immediate, such that transfer of the media item to the local archive begins when the operation is received. Alternatively, the download operation can be delayed, such as until the media item is needed for playback or until the next synchronization operation is performed.

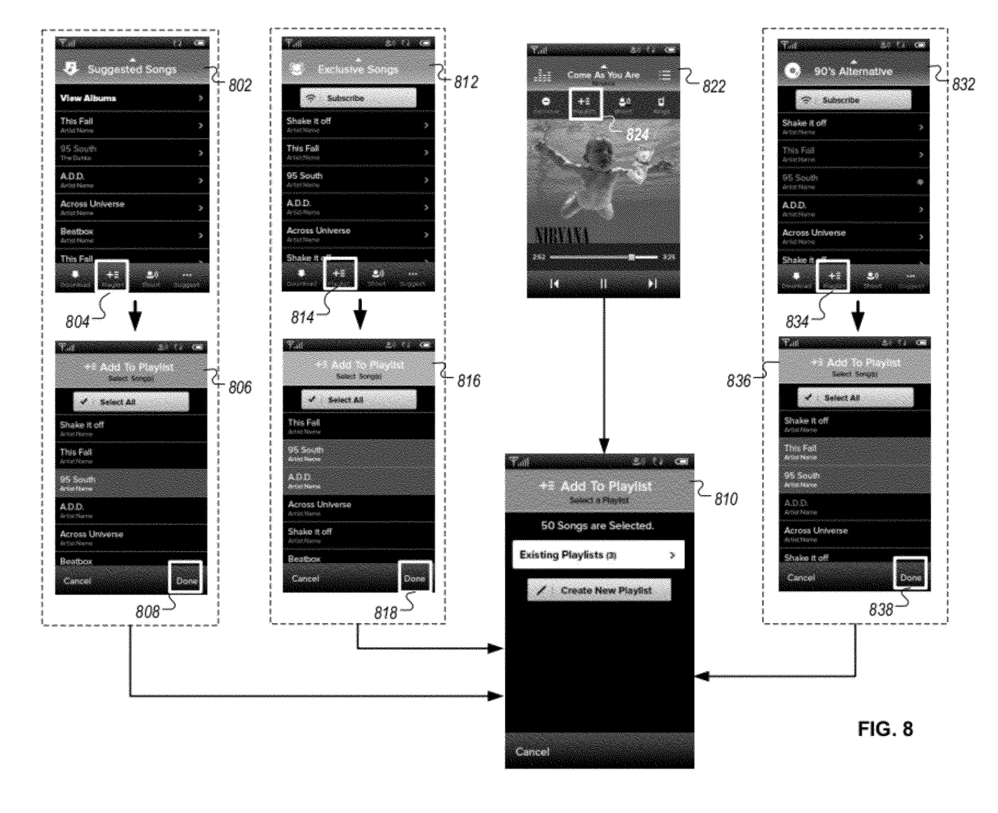

FIG. 8 shows exemplary playlist management interfaces corresponding to a variety of functional areas. Playlist management can be performed from one or more functional areas of the media application, by selecting a playlist icon or playlist command button presented in an interface. For instance, an interface displaying one or more items of media content, either local or remote, also can include a playlist command button, which can be actuated to add any selected item or items of media content to a playlist.

For instance, a playback interface 822 can be presented during playback of an item of media content, e.g. a song. The playback interface 822 can include one or more user interface commands, controls, and widgets, e.g. implemented using buttons and sliders, that can be used to control playback. The playback interface 822 also can include a playlist button 824, which can be selected to add the item of media content being played back to a playlist. Upon selection of playlist button 824, a playlist management interface 810 can be presented. The playlist management interface 810 can function as described with respect to FIG. 7. For instance, the playlist management interface 810 can include an option to view the existing playlists to which the selected media content can be added. The option also can indicate how many existing playlists can be modified to include the selected media content. Selecting the option can cause the editable, local playlists to be presented. Also, the playlist management interface 810 can include an option to create a new playlist based on the selected media content. Selecting the option to create a new playlist can cause an input interface to be presented, such that a user can assign a name or other identifier to the newly created playlist.

Other interfaces of the media application also can include a playlist command button. For instance, a GetMusic interface 802 showing a list of suggested songs (or tracks) can include a playlist command button 804. Also, a GetSocial interface 812 showing a list of songs that are exclusive to the user or another subscriber, e.g. a friend or neighbor, can include a playlist command button 814. Further, a MyDJ interface 832 showing a list of songs associated with a playlist also can include a playlist command button 834. Selecting the playlist command button 804, 814, or 834 can cause a corresponding playlist selection interface 806, 816, or 836 to be presented. The playlist selection interface can include a listing of the same media content items presented in the preceding interface and can be configured to permit any or all of those media content items to be selected. After one or more of the media content items have been selected, a done button 808, 818, or 838 included in the playlist selection interface can be actuated to advance to the playlist management interface 810, through which the selected items of media content can be added to an existing playlist or a new playlist can be created based on the selected items of media content.

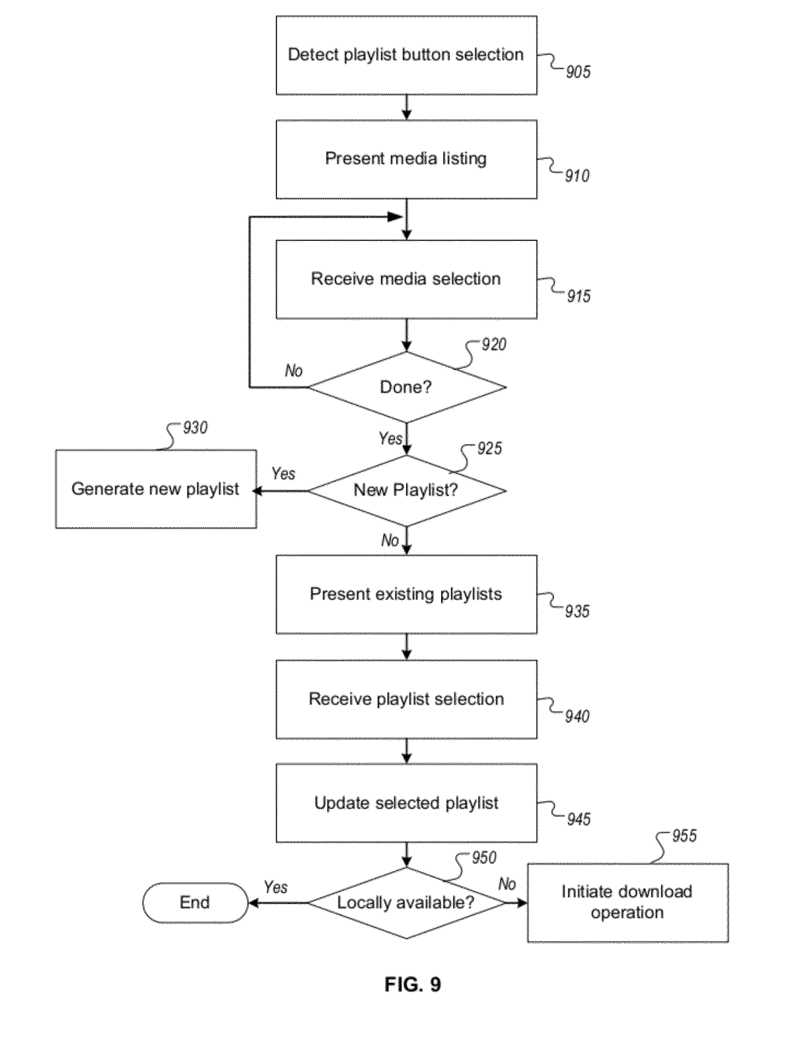

FIG. 9 shows an exemplary process flow for playlist management. A playlist button can be included in various interfaces of the media application, such as interfaces that identify one or more items of media content, including local interfaces and remote interfaces, e.g. one or more GetMusik and GetSocial interfaces. The selection of the playlist button can be detected (905) in an interface and a playlist management process can be initiated. A media listing can be generated and presented in response to the selection of the playlist button (910). The media listing can include one or more items of media content shown in the interface from which the playlist button was selected. Further, the media listing can include zero, one, or more additional items of media content. The selection of an item of media content from the media listing can be received (915) and it can be determined whether any more selections are to be made (920). For instance, it can be determined whether input indicating an end of the media selection, e.g. a done command, has been received. If media selection is on-going, an additional media selection can be received (915). Otherwise, it can be determined whether a new playlist is to be created (925). For instance, a playlist interface can be presented, prompting the subscriber to select an option to create a new playlist or to modify an existing playlist.

If a new playlist is to be created, an interface can be provided to permit assigning an identifier to the new playlist and the new playlist can be generated (930). Alternatively, a playlist identifier can be automatically generated. Otherwise, a listing of one or more existing playlists can be presented (935) and one of the existing playlists can be selected (940). The selected playlist can then be updated to include the one or more selected items of media content (945). Additionally, it can be determined whether any item of selected media content is not presently stored in the local media archive (950). If an item of selected media content is not stored in the local media archive, a download operation can be initiated to transfer the item of media content (955).

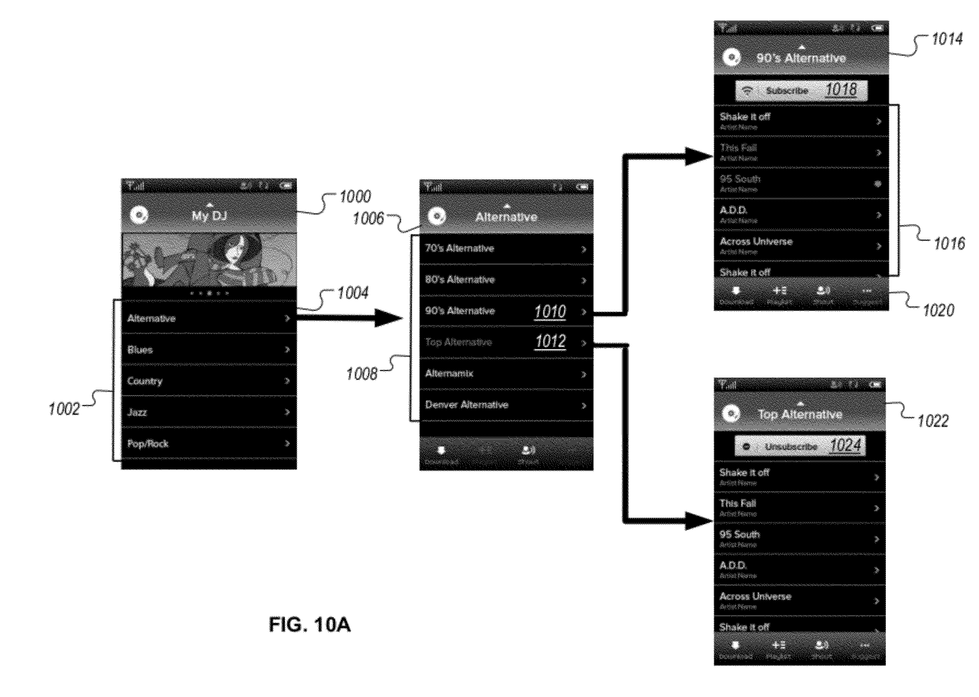

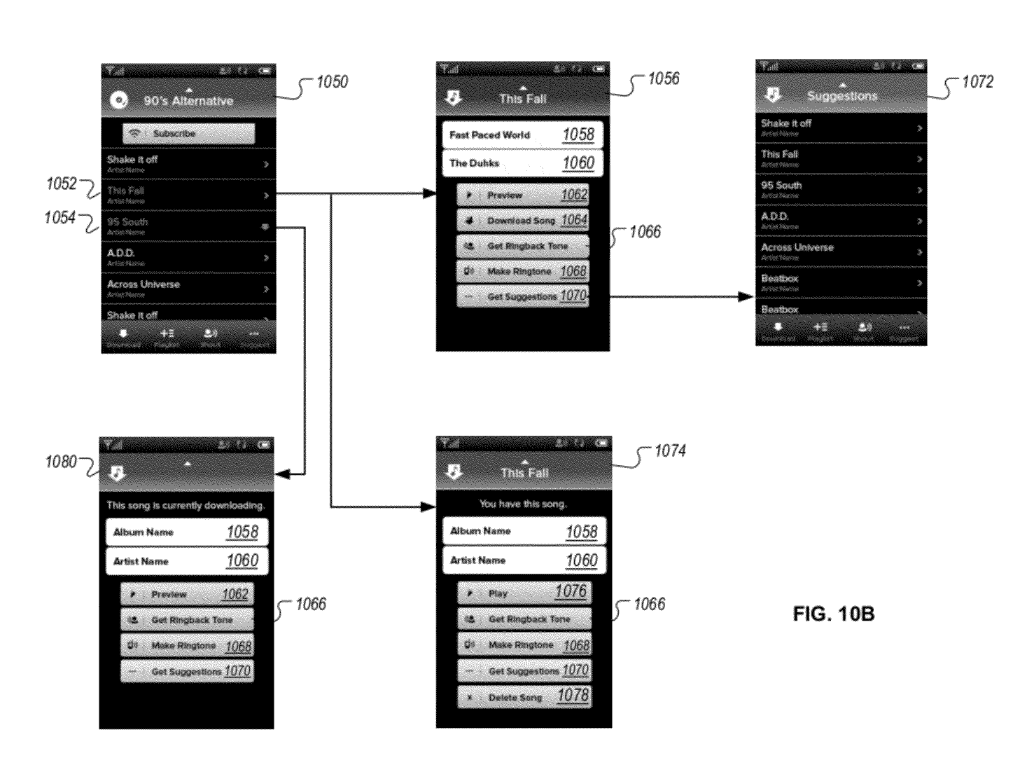

FIGS. 10A and B show exemplary interfaces relating to playlist functionality in the media application. Access to and maintenance of playlists can be performed through the MyDJ functional area of the media application. The playlists can include all playlists accessible to the subscriber, including external playlists created and maintained by third parties, e.g. system administrators and other subscribers, and local playlists created and maintained by the subscriber. The playlists can provide a subscriber with an opportunity to discover media that was previously unknown to them, e.g. by introducing the subscriber to a broad range of music within one or more selected genres. Further, the subscribed playlists can be automatically updated by the party that maintains them. In response to updating, media content added to a subscribed playlist can be automatically downloaded to the local media archive of the subscriber's mobile communications device. In some implementations, media removed from a subscribed playlist also can be removed from the subscriber's local media archive. For instance, a flag, or other such indicator, can be set for an item of media content to indicate that it has been added to the local media archive independent of a subscribed playlist. If the flag is not set for an item of media content removed from a subscribed playlist, the item of media content can be removed from the local media archive when it is removed from the corresponding subscribed playlist. Additionally, the timing of automatic updates for a subscribed playlist can be based on the frequency with which the playlist is accessed. For instance, a frequently accessed playlist can be updated more often than a playlist that is infrequently accessed. Alternatively or additionally, the local media archive can be updated to reflect the current state of a playlist when that playlist is accessed.

FIG. 10A shows a MyDJ interface 1000 corresponding to the home of the MyDJ functional area, which provides access to the available playlists. The view of subscribed, unsubscribed, and local playlists can be organized in any manner within the MyDJ (or playlist) area. In one implementation, the MyDJ interface 1000 can include a list of genres 1002 under which the available playlists can be categorized. For instance, the list of genres 1002 can include an alternative category 1004, which can include one or more sub-categories of alternative music. A genre can be selected from the list of genres 1002 through any input mechanism, including touch or through a cursor.

In response to the selection of a genre, e.g. the alternative category 1004, a genre level interface can be presented, e.g. the alternative interface 1006. The genre level interface can include a list of the available playlists included in that category. For instance, the alternative list 1008 can include entries for each of the available alternative music playlists, such as Alternamix and Denver Alternative. Presently unsubscribed playlists also can be visibly distinguished from subscribed and local playlists, e.g. through text and/or color, or an associated graphical device (e.g. an icon). Thus, a subscriber can visually distinguish existing content that is available for playback from new content that can be explored.

Further, a playlist can be selected from the list of playlists, e.g. alternative list 1008, to view the media associated with that playlist. For instance, the 90's Alternative interface 1014 is presented in response to selection of the entry 90's Alternative 1010 from the alternative list 1008. The 90's Alternative interface 1014 can include a track listing 1016 that identifies the tracks included in the playlist. If a track listing is longer than the available display space, the track listing can be adapted to be scrollable, e.g. through inclusion of a scroll-bar. The track listing 1016 also can be configured such that tracks stored in the local media archive are visibly distinguished from remote tracks, e.g. through text and/or color, or an associated graphical device. Accordingly, the subscriber can determine, in addition to reviewing the track listing, how many tracks in the playlist already are stored locally. Also, the 90's Alternative interface 1014 can include a subscribe button 1018 to facilitate subscription to the playlist through a single-command entry. A suggestion button 1020 also can be included to permit the subscriber to access one or more suggestions for related media content, e.g. playlists, albums, and/or artists.

A playlist that already has been subscribed to also can be selected from the alternative list 1008. For instance, the Top Alternative 1012 playlist can be visibly identified as a subscribed playlist in the list of available playlists. In response to selecting the Top Alternative 1012 entry, the Top Alternative interface 1022 can be displayed. The Top Alternative interface 1022 can include a track listing that identifies each of the tracks presently associated with that playlist. Further, the Top Alternative interface 1022 can include an unsubscribe button 1024 to permit the subscriber to cancel the subscription to that playlist.

FIG. 10B shows selection of a song from a playlist interface. For instance, 90's Alternative interface 1050 can include a track listing showing numerous track names, e.g. This Fall 1052 and 95 South 1054. In response to selecting a track from the track listing, a corresponding track interface can be displayed. The track interface can be differently configured, depending on whether the selected track has been downloaded to the local media archive, is being downloaded to the local media archive, or has not been downloaded to the local media archive.

For instance, if the track This Fall 1052 is selected but has not been downloaded, a remote track 1056 interface can be presented. The remote track 1056 interface can include a number of commands and features, including an album button 1058 that can be selected to view all of the tracks included on the associated album and an artist button 1060 that can be selected to view all of the works, e.g. albums or tracks, by the associated artist. The remote track 1056 interface also can include a preview button 1062 that can be selected to listen to a preview of the track, a download song button 1064 that can be selected to download a copy of the track to the local media archive, a get ringback tone button 1066 that can be selected to download a ringback tone based on the track, a make ringtone button 1068 that can be selected to make a ringtone based on the track, and a get suggestions button 1070 to retrieve one or more suggestions for media content related to the track. For instance, selecting the get suggestions button 1070 can cause a suggestions interface 1072 to be presented that identifies one or more similar tracks that can be downloaded or further accessed.

Alternatively, if the track This Fall 1052 is selected and already has been downloaded, e.g. if a download was requested and has been sufficiently completed, a local track interface 1074 can be presented. The local track interface 1074 can include a number of commands and features associated with the remote track interface 1056, including the album button 1058, artist button 1060, get ringback tone button 1066, make ringtone button 1068, and get suggestions button 1070. Also, the local track interface 1074 can include one or more unique command buttons, such as a play button 1076 to play the track and a delete button 1078 to delete the track from the local media archive.

In response to selection of a track that is still in the process of being downloaded, e.g. 95 South 1054, a download track interface 1080 can be presented. The download track interface 1080 can include a subset of the commands and features associated with the local and remote track interfaces, such as the album button 1058, artist button 1060, preview button 1062, get ringback tone button 1066, make ringtone button 1068, and get suggestions button 1070.

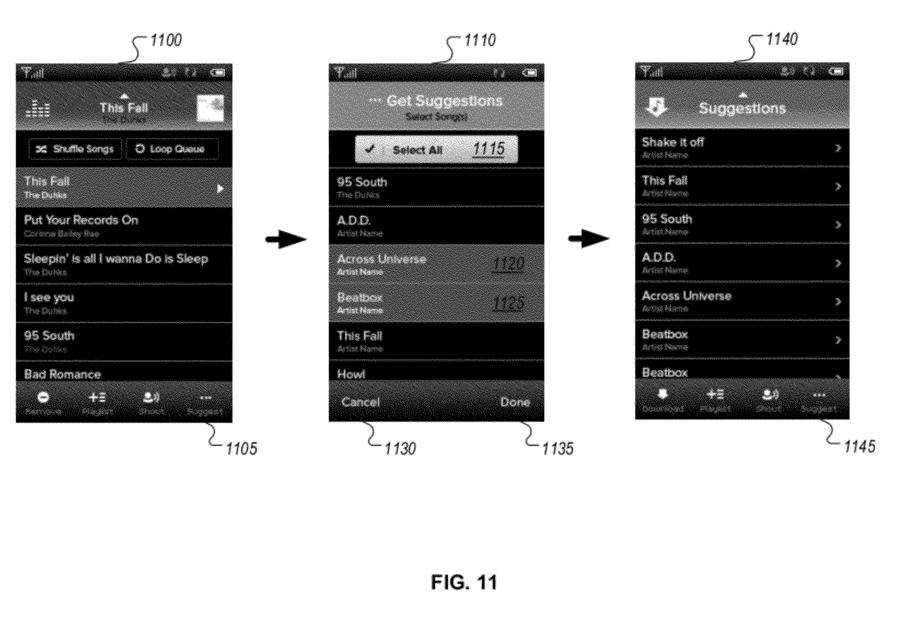

FIG. 11 shows exemplary media application interfaces for receiving suggestions. Suggestions of related media items can be provided in response to the identification of one or more items of media, e.g. songs. The suggestions can be generated based on the similarity between the one or more identified media items and other media items included in an available media archive. In some implementations, subscriber data can be analyzed to determine or refine the degree of relatedness between two items of media content. For instance, if a significant portion of subscribers who have track A in their local media archive also have track B in their local media archive, a measure representing the degree of relatedness between tracks A and B can be increased. The suggestions can be provided by the media service in real-time.

A playlist interface 1100 can be presented, which includes a list of tracks scheduled to be played. The playlist interface 1100 also can include a suggestions button 1105, which can be selected to receive one or more suggested tracks. A suggestion button also can be included in one or more other interfaces, including other MyMusic interfaces and interfaces from the MyDJ, GetMusic, and GetSocial functional areas. In response to selection of the suggestion button 1105, a get suggestions interface 1110 can be presented. The get suggestions interface 1110 can include a listing of tracks, e.g. from the playlist interface 1100. All of the tracks can be selected by actuating the select all button 1115. Alternatively, one or more tracks can be individually selected, such as Across Universe 1120 and Beatbox 1125. The suggestion process can be canceled at any time by actuating the cancel button 1130. Otherwise, the done button 1135 can be actuated once the desired tracks have been selected from the get suggestions interface 1110.

A suggestions interface 1140 can be presented in response to actuation of the done button 1135. The suggestions interface 1140 can include a list of one or more suggested tracks that are related to the one or more tracks selected in the get suggestions interface 1110. Any of the suggested tracks can be downloaded, added to a playlist, or included in a Shout message from the suggestions interface 1140, e.g. by selecting the corresponding command button. Further, one or more of the suggested tracks can be selected and the suggest button 1145 can be actuated to receive further suggestions based on the one or more selected suggested tracks.

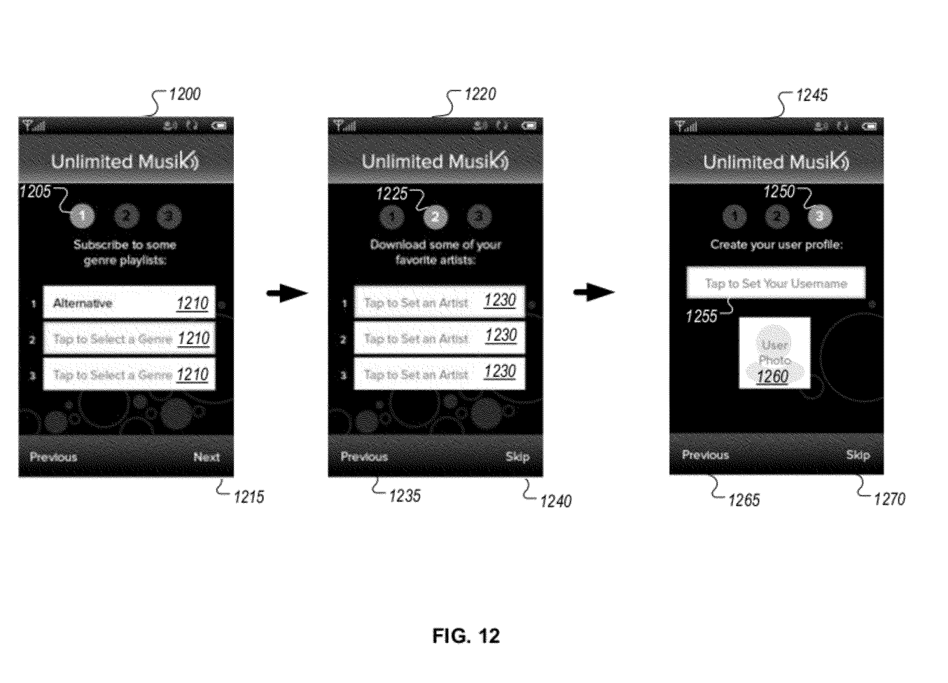

FIG. 12 shows exemplary interfaces associated with a setup wizard of the media application. The setup wizard can be executed at any time, e.g. when a subscriber first initiates service or when the subscriber desires to reconfigure their account. A wizard genre interface 1200 can be presented to receive the specification of one or more genres from the subscriber. The wizard genre interface 1200 can include a step indicator 1205 to indicate which step of the setup process is being performed and also can include one or more instructions, such as “Subscribe to some genre playlists:”. Further, the wizard genre interface 1200 can include one or more genre text boxes 1210 to receive an identification of a genre. A genre text box 1210 can be implemented as a form entry box into which text can be entered, a drop down menu box pre-populated with one or more selectable items, or any other interface element. Alternatively, selecting a genre text box 1210 can cause a genre selection interface to be presented, which can include any combination of interface elements, including any or all of a search box, a text entry box, and a list of selectable genres. A next button 1215 can be provided to permit a subscriber to move to the next step. In some implementations, a skip button can be provided in addition to or in place of the next button 1215, to permit a subscriber to skip this step of the wizard process.

Once one or more artists have been specified or the next button 1215 has been actuated, a wizard artist interface 1220 can be presented. The wizard artist interface 1220 can include a step indicator 1225 to indicate which step of the setup process is being performed, e.g. the second step, and also can include one or more instructions, such as “Download some of your favorite artists”. Further, the wizard genre interface 1220 can include one or more artist text boxes 1230 to receive an identification of an artist. An artist text box 1230 can be implemented as a form entry box into which text can be entered, a drop down menu box pre-populated with one or more selectable items, or any other interface element. Alternatively, selecting an artist text box 1230 can cause an artist selection interface to be presented, which can include any combination of interface elements, including any or all of a search box, a text entry box, and a list of selectable artists. In some implementations, one or more artists can be presented in response to one or more genre selections received through the wizard genre interface 1200. Additionally, a previous button 1235 can be provided to permit a subscriber to return to the previous step and a skip button 1240 can be included to permit a subscriber to skip this step.

Once one or more artists have been specified or the skip button 1240 has been actuated, a wizard profile interface 1245 can be presented. The wizard profile interface 1245 can include a step indicator 1250 to indicate which step of the setup process is being performed and also can include one or more instructions, such as “Create your user profile”. Further, the wizard profile interface 1245 can include a username text box 1255 and a photo box 1260, which can be configured to receive input of username and user photo, respectively. Additionally, a previous button 1265 can be provided to permit a subscriber to return to the previous step and a skip button 1270 can be included to permit a subscriber to skip this step of the wizard process. Upon completion of the wizard process, the subscriber's local media archive can be automatically populated with media corresponding to the one or more identified artists and genres, including subscribed playlists corresponding to the one or more identified genres. Further, additional media content that is related to or otherwise reflects any or all of the identified artist and genre selections also can be automatically downloaded to the subscriber's local media archive.

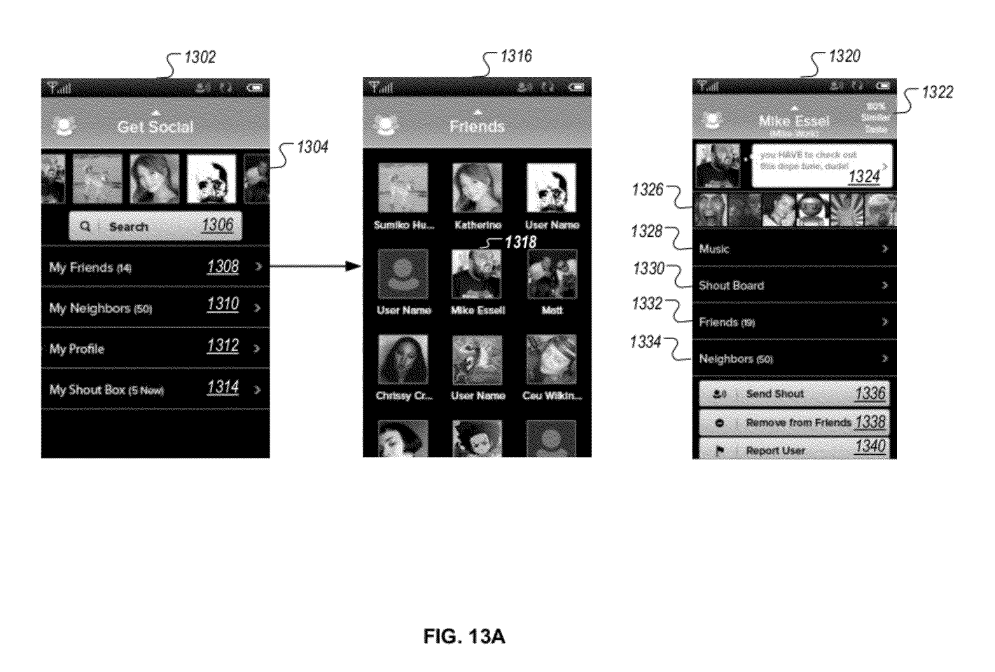

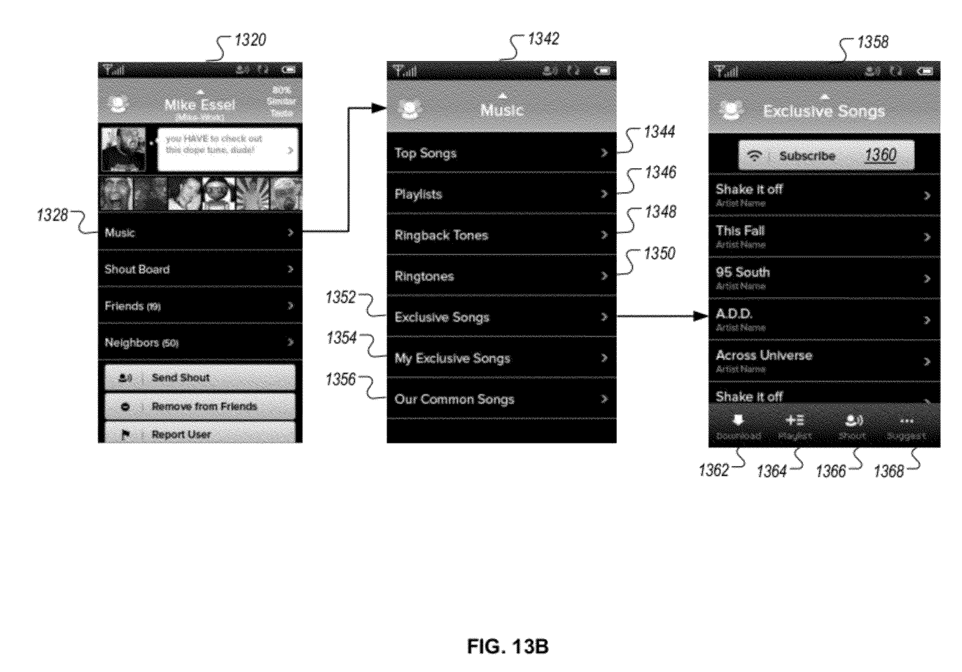

FIGS. 13A and B show exemplary media application interfaces for social interaction in the media application. Social interaction in the media application can be organized through the GetSocial functional area, although aspects of social interaction also can be implemented in one or more other functional areas. A GetSocial interface 1302 can be presented as the top level interface for social functionality. The GetSocial interface 1302 can include features and commands relating to interactions with other subscribers, including subscribers expressly designated as friends and subscribers designated by the media service as neighbors. For instance, the media service can designate one or more other subscribers as neighbors based on one or more factors, such as one or more of geographical proximity, common friends, and media preferences. In some implementations, one or more of the factors evaluated to determine whether two subscribers should be identified as neighbors can be weighted, e.g. in accordance with the factor's respect importance. For instance, two subscribers having nearly identical musical tastes can be identifies as neighbors even though they are geographically distant. Further, one or more factors can serve as thresholds. For instance, a particular geographical proximity, e.g. less than 500 miles, can be required to designate two subscribers as neighbors.

The GetSocial interface 1302 can include a banner 1304 showing images representing some or all of the subscriber's friends and/or neighbors. In some implementations, banner 1304 can be scrollable, e.g. in response to touch input. Additionally, in some implementations, the media application can communicate with one or more contacts databases maintained on the mobile communications device, e.g. through an API, to identify contacts who can be added as friends if they also are subscribers, to add contact entries corresponding to individuals identified as friends, or both.

GetSocial interface 1302 also can include a search button 1306, which can be used to access a search tool. The search tool can be used to search, e.g. through one or more keywords, for individuals, e.g. friends, neighbors, or contacts. A listing of friends and neighbors also can be accessed directly. For instance, MyFriends button 1308 can be actuated to show all of the individuals the subscriber has designated as friends, e.g. in friends interface 1316. Also, MyNeighbors button 1310 can be actuated to show all of the individuals who have been designated, e.g. by the media service, as neighbors of the subscriber. Further, MyProfile button 1312 can be actuated to present a profile interface, through which aspects of the subscriber's profile can be accessed, such as the subscriber's music, shout message board, friends, and neighbors. Additionally, a MyShoutBox button 1314 can be included to provide direct access to messages (shouts) received through the media service. In some implementations, the MyShoutBox button 1314 can be presented only when new messages are in the message box.

Friends interface 1316 can include images representing others the subscriber has designated as friends. The images can be photos, avatars, or other representative images. Also, a text identifier, e.g. a user name or screen name, can be associated with the image and can be persistently displayed or presented based on interface input, such as the positioning of a cursor. Further, an image can be selected through interface input to access an interface of the corresponding friend. For instance, selecting friend image 1318 representing Mike Essel can cause the profile interface 1320 for that friend to be presented.

The profile interface 1320 can include a match identifier 1322, indicating the degree of commonality between the subscriber's local media archive and the friend's local media archive. Also, the most recent public message posted by the friend can be presented in a Shout bubble 1324. A scrollable banner 1326 showing friends and/or neighbors of the accessed friend also can be presented, along with buttons to access public areas of the friends profile, including music 1328, Shout board 1330, friends 1332, and neighbors 1334. Additionally, one or more command buttons can be included in profile interface 1320 to permit interaction with or about the friend, including SendShout button 1336 to send a message to the friend, RemoveFromFriends button 1338 to remove the friend from the subscriber's list of friends, and ReportUser button 1340 to report the friend to the media service.

FIG. 13B shows an exemplary music interface 1342, which can be presented in response to actuating the music button 1328. The music interface 1342 can present multiple categories of the friend's local music archive, which can be explored. For instance, the music interface 1342 can include options to access the friend's top songs 1344, playlists 1346, ringback tones 1348, and ringtones 1350. Further, the music interface 1342 can include one or more options for comparing the subscriber's local media archive with that of the friend. For instance, the Exclusive Songs category 1352 can be accessed to present an Exclusive Songs interface 1358 showing a listing of songs that are included in the friend's local media archive but not in the subscriber's local media archive. In contrast, the category My Exclusive Songs 1354 can be accessed to show a listing of songs that are exclusive to the subscriber's local media archive, e.g. which can be recommended through a Shout message. Additionally, the category Our Common Songs 1356 can be accessed to show a listing of songs appearing in the local media archive of both the subscriber and the friend.

The Exclusive Songs interface 1358 also can include features and commands to permit the subscriber to perform operations relating to the list of songs. For instance, a subscribe button 1360 can be actuated to subscribe to the friend's exclusive tracks. Also, one or more tracks can be selected from the listing and operated on using the download button 1362, the playlist button 1364, the shout button 1366, and the suggest button 1368. With the exception of downloading and subscribing, similar operations can be performed in interfaces corresponding to the subscriber's exclusive tracks and common tracks.

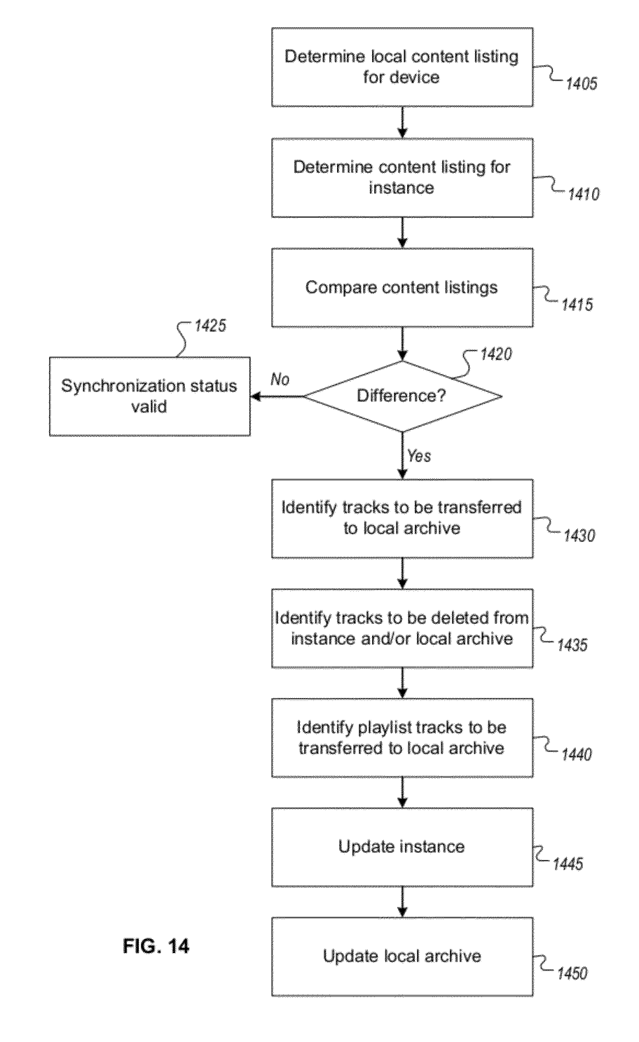

FIG. 14 shows an exemplary process flow for transferring media content to mobile communications device. The cloud can maintain a persistent instance of the subscriber's local media archive, e.g. that is maintained on secure storage at the subscriber's mobile communications device. In some implementations, a separate instance can be maintained for each secure storage device employed by the subscriber, e.g. such that each secure storage device is treated as a separate logical archive. The synchronization status for a subscriber is valid (or current) when the state of the instance maintained at the cloud matches the state of the subscriber's local media archive. If a change occurs at one of the cloud level and the local device level, the synchronization status is no longer valid. The synchronization state can be maintained in any manner, such as a flag or binary value indicating that the synchronization state is current or that the local device is out of synchronization with the cloud. A message, e.g. an SMS message, can be transmitted to the subscriber's device when the synchronization state changes to reflect that synchronization is required. No additional messages need be transferred after synchronization has lapsed, since the subscriber's device already has been notified that it needs to synchronize.

A synchronization operation can be performed periodically, e.g. once a day or when communication is established between a mobile communications device and the cloud, to execute any required updates. The local content listing, e.g. the contents of the local media archive, can be determined for the subscriber's mobile communications device (1405). The corresponding content listing for the subscriber's instance maintained at the cloud also can be determined (1410). For example, a listing of unique track identifiers can be generated for both the mobile communications device and the cloud instance.

Once determined, the local content listing can be compared with the corresponding content listing for the subscriber's instance (1415). Further, it can be determined whether there are any differences (1420). If no differences exist between the local content listing and the corresponding content listing for the subscriber's instance, the synchronization status is confirmed to be valid and no updating is performed (1425).

Otherwise, if at least one difference exists between the local content listing and the corresponding content listing for the subscriber's instance, it can be determined what content requires updating. In some implementations, one or more change lists can be generated to capture content updates that are to be performed, e.g. a change list for the subscriber device and a change list for the instance. In some other implementations, an update can be performed as it is identified.

Based on the comparison of the local content listing to the corresponding content listing for the subscriber's instance, any tracks that are to be transferred to the local media archive of the subscriber's device can be identified (1430). For example, all of the tracks associated with the subscriber's account, as reflected by the instance at the cloud, can be compared to the tracks stored in the local media archive. If a track is included in the instance at the cloud but is not included in the local media archive, the track can be identified for download. This situation can arise where a user has requested a track, e.g. through the web-management interface or from the mobile communications device, but the track has not yet been downloaded.

Any tracks that are to be deleted from either or both of the instance at the cloud and the local media archive also can be identified (1435). For example, a track can be deleted from a subscribed playlist and thus also can be deleted from the instance maintained at the cloud. Based on the comparison, it can be determined that the track also is to be deleted from the local media archive. In some implementations, before a track is deleted from the instance in response to its removal from a subscribed playlist, it can be determined whether the track was downloaded to the local media archive independent of the playlist, e.g. in response to a subscriber's request, or if the track is still included in another subscribed playlist. Independence from the playlist can be determined by an identifier, such as a flag or source value. If the track was independently added to the local media archive or is still included in another subscribed playlist, deletion from one playlist will not cause the track to be deleted from the instance. Additionally, a track that has been deleted from the local media archive, e.g. by subscriber action, also can be deleted from the instance maintained at the cloud.

Further, any tracks included in a subscribed playlist that are not included in the local media archive also can be identified for transfer to the local media archive (1440). For example, new tracks can be added to a subscribed playlist. If it is determined during the comparison that one or more of the new tracks is not included in the local media archive, those one or more tracks can be identified for download. The instance maintained at the cloud can be updated to reflect any changes identified as a result of the comparison (1445). For example, one or more tracks deleted from the local media archive since the last synchronization can be deleted from the instance. Also, the local media archive can be updated to reflect any identified changes (1450). In some implementations, the updating can be performed as each change is identified, e.g. in real time. In some other implementations, one or more change lists can be generated during the comparison process and the updating can be performed by executing one or more of the change lists. After the updating, the synchronization status is once again confirmed to be valid.

In some implementations, change records can be maintained by both the subscriber device and the cloud. For instance, each change, such as the deletion of one or more tracks or the creation of a new playlist, that is performed at the local media archive level after a synchronization operation has terminated can be recorded until the next synchronization operation occurs. Similarly, each change, such as the addition to or deletion from a subscribed playlist of one or more tracks, can be identified in a change record associated with the subscriber's instance maintained at the cloud. During the next synchronization operation, the change record associated with the local media archive can be accessed and the local changes can be applied to the subscriber's instance at the cloud. Further, the change record associated with the subscriber's instance at the cloud can be accessed and the cloud-based changes can be applied to the subscriber's local media archive. Once the changes included in the change records maintained by the subscriber device and the cloud have been implemented, the synchronization status can be reset.

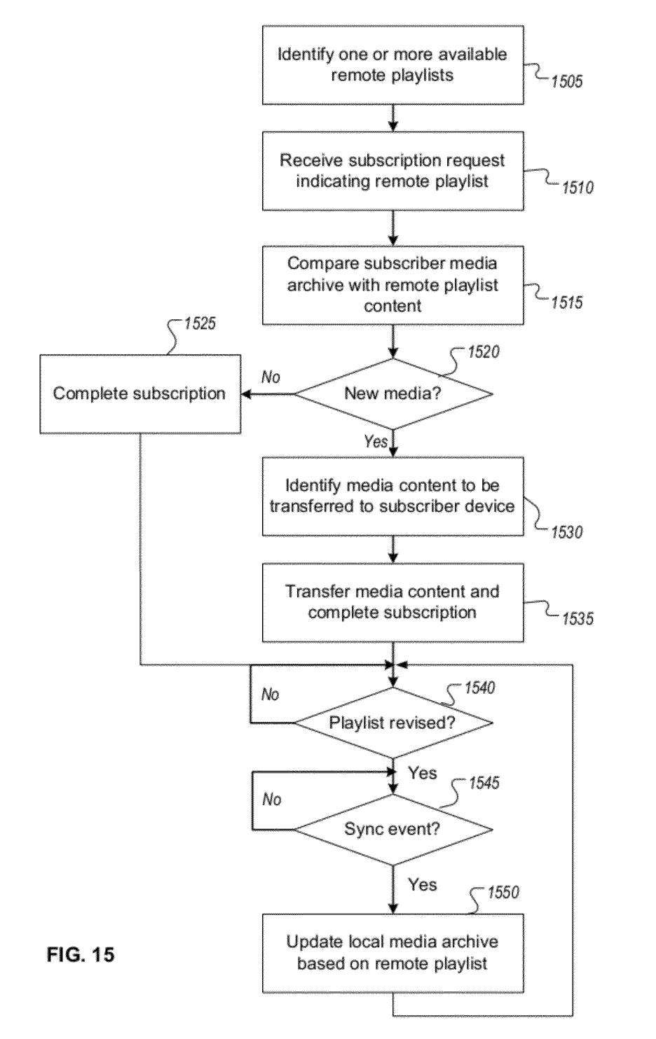

FIG. 15 shows an exemplary process flow for providing content corresponding to a subscribed play list. Remote play lists (or remote playlists) can be maintained in the media server environment and made available through subscription to one or more music service subscribers. A remote play list can be generated by anyone other than the subscriber. For instance, a system play list can be generated to introduce subscribers to music within a particular genre, such as alternative or jazz. The system playlist can be generated manually or automatically, e.g. based on collected statistics, artificial intelligence, or a combination thereof. A system play list also can be sponsored by a celebrity, such as a popular musician within a genre. Further, a user play list can be generated by another subscriber, such as a friend or neighbor. A music service subscriber can establish a subscription to any of these remote play lists. Once a subscription has been established, the subscriber's local media archive can be updated automatically to include all of the media associated with the playlist. Also, media can be purged from the subscriber's local media archive when it removed from the playlist.

One or more available remote playlists can be identified to a subscriber (1505). For instance, a list of available remote playlists can be presented in response to the subscriber accessing a portion of a media archive, e.g. a music store or playlist repository. The available remote playlists also can be organized, e.g. based on genre, artist, playlist creator, or other such characteristics. Alternatively or additionally, one or more remote playlists can be discovered by exploring a local media archive of another subscriber, such as a friend or neighbor. For instance, the playlists created by that friend or neighbor can be viewed, including the associated media content.

A subscription request indicating a remote playlist can be received from a subscriber (1510). For instance, each playlist in the music service system can be assigned a unique identifier by which it can be accessed and managed. The local media archive of the requesting subscriber can be compared with the content included in the remote playlist corresponding to the request (1515). Based on the comparison, it can be determined whether the remote playlist includes any media that is not already stored in the subscriber's local media archive (1520). If all of the media included in the remote playlist is stored in the subscriber's local media archive, the subscription can be completed and the subscriber can use the subscribed playlist (1525).

If one or more items of media included in the remote playlist are not included in the subscriber's local media archive, the one or more items of media can be identified for transfer (or downloading) to the subscriber's mobile communications device for storage in the local media archive (1530). For instance, the one or more items of media can be added to a download queue. In some implementations, if the download queue includes multiple items, the items in the download queue can be prioritized for transfer. For instance, media that the subscriber has requested for immediate play back can be given the highest priority and transfer can begin as soon as possible. Further, the remaining media content can be prioritized based on one or more criteria, such as popularity, how recently the media content was added to the media catalog, the position of the media content within the subscribed play list, and how long the media content has been awaiting transfer. The media content can be transferred to the device in accordance with the prioritization, such that the highest priority content is transferred first. Alternatively, the one or more items can be transferred in conjunction with the next synchronization operation based on their addition to the subscriber's instance maintained at the cloud. The subscription to the remote playlist can be completed and the identified media can be transferred (1535). For instance, the subscription to the remote playlist can be added to the subscriber's instance maintained at the cloud.

After the subscription has been completed, the music service can periodically determine whether the remote playlist has been revised (1540). In response to a revision, it further can be determined whether a synchronization event has occurred (1545). One or more predetermined synchronization events or conditions can be defined, such as entering a local service area during off peak hours or connecting the mobile communications device to a power source. In some implementations, a synchronization event can be a complex event that includes multiple conditions. Additionally, playlist updating can incorporate a use-based component. For instance, a frequently accessed playlist can be updated whenever the playlist is revised. On the other hand, an infrequently accessed playlist can be updated only after a predetermined period of time, e.g. a week, because the playlist content will still be relatively fresh even without updating. Accordingly, the amount of data transferred to update playlists can be reduced.

If a synchronization event has occurred, the subscriber's local media archive can be updated based on the remote playlist (1550). For instance, media that has been added to the remote playlist and is not already stored in the subscriber's local media archive can be downloaded. Further, an item of media that has been removed from the remote playlist can be deleted from the subscriber's local media archive, e.g. if the item of media was not added to the local media archive independent of the remote playlist subscription or otherwise flagged for retention.

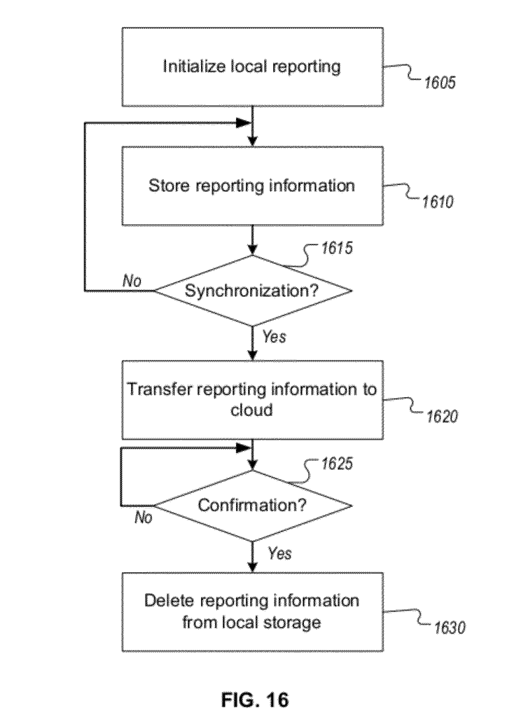

FIG. 16 shows an exemplary process flow for recording information on a mobile communications device and reporting the information to the cloud. Information relating to a variety of activities can be recorded on the mobile communications device during operation, between synchronization operations with the cloud. For instance, statistics regarding playback and deletion of media content can be collected during operation. Also, statistics regarding the configuration, access, and use of ringtones and ringback tones can be collected.

Local reporting can be initialized on a mobile communications device participating in the media service (1605). After reporting has been initialized, reporting information can be stored locally, e.g. in a database or file (1610). The information that is collected in conjunction with reporting can vary based on the requirements or preferences specified by the media service. For example, playback information can be collected to determine what media the user is accessing and how, including one or more of a unique track identifier for each playback instance, a date/time the playback is started, and a date/time the playback is halted. Further, the granularity of one or more items of information can be specified, such as determining times to the second or millisecond. Other items of information also can be captured, including ringtone information, ringback tone information, messaging information, and browsing information, such as tracks, playlists, and social resources the subscriber accessed.

Further, it can be determined whether a synchronization operation has been initiated (1615). If synchronization has not been initiated, the collection and storage of reporting information can continue (1610). Otherwise, if a synchronization operation is occurring, the locally stored reporting information is transferred to the cloud (1620). Once transferred, the reporting information can be accessed by one or more cloud resources. For instance, the locally recorded playback statistics can be used to derive information regarding the genres, artists, and albums the subscriber is playing, and to calculate the top tracks and/or albums for any or all genres. Accordingly, playback statistics can be used to generate media system wide statistics for purposes including providing recommendations, developing programming, and creating playlists. The playback statistics also can be used to formulate personal recommendations for the subscriber, e.g. based on the items of media for which the subscriber has shown a preference. Further, usage statistics, e.g. for ringtones and ringback tones, can be used to determine the amount of compensation due to content providers.

The mobile communications device can determine whether confirmation of the transfer has been received from the cloud (1625). If confirmation has not been received, the mobile communications device can continue to wait for confirmation, e.g. until the synchronization process is terminated. If confirmation is received, the locally stored reporting information has been successfully transferred to the cloud and can be deleted from the local storage (1630). Accordingly, the amount of reporting information that is stored locally at any given time can be limited to preserve storage capacity.

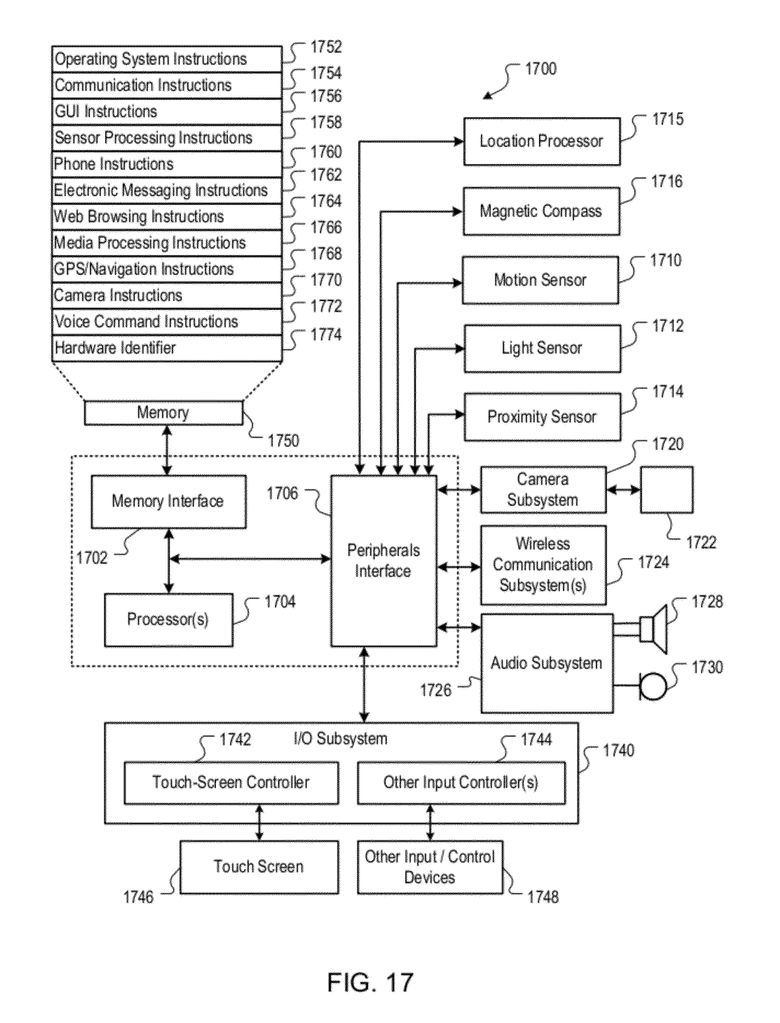

FIG. 17 is a block diagram of an exemplary architecture 1700 of a data processing device, such as the communications device 115, 125, 315 and 410. The communications devices 115, 125, 315 and 410 can include a memory interface 1702, one or more data processors, image processors and/or central processing units 1704, and a peripherals interface 1706. The memory interface 1702, the one or more processors 1704 and/or the peripherals interface 1706 can be separate components or can be integrated in one or more integrated circuits. Various components in the data communication devices 115, 125, 315 and 410 can be coupled together by one or more communication buses or signal lines.

Sensors, devices, and subsystems can be coupled to the peripherals interface 1706 to facilitate multiple functionalities. For example, a motion sensor 1710, a light sensor 1712, and a proximity sensor 1714 can be coupled to the peripherals interface 1706 to facilitate the orientation, lighting, and proximity functions. A location processor 1715 (e.g., GPS receiver) can be connected to the peripherals interface 1706 to provide geopositioning. A magnetic compass integrated circuit 1716 can also be connected to the peripherals interface 1706 to provide orientation (e.g., to determine the direction of due North).

A camera subsystem 1720 and an optical sensor 1722, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 1724, which can include radio frequency receivers and transmitters and/or optical (e.g., infrared) receivers and transmitters. The specific design and implementation of the communication subsystem 1724 can depend on the communication network(s) over which the data communication devices 115, 125, 315 and 410 is intended to operate. For example, communications devices 115, 125, 315 and 410 may include communication subsystems 1724 designed to operate over a GSM network, a GPRS network, an EDGE network, a Wi-Fi or WiMax network, and a Bluetooth™ network. In particular, the wireless communication subsystems 1724 may include hosting protocols such that the communications devices 115, 125, 315 and 410 may be configured as a base station for other wireless devices.

An audio subsystem 1726 can be coupled to a speaker 1728 and a microphone 1730 to facilitate voice-enabled functions, such as voice recognition, voice replication, digital recording, and telephony functions.

The I/O subsystem 1740 can include a touch screen controller 1742 and/or other input controller(s) 1744 to control the inputs and outputs of the communications devices 115, 125, 315 and 410. For example, the I/O subsystem 1740 can include a microphone (internal and/or external), a speaker and a voice command recognition engine. The I/O subsystem 1740 can receive voice commands and present audio outputs over full duplex communication. For example, transport technologies other than regular cellular voice communications, such as voice over IP, can be implemented.

Also, voice commands can be processed using a two-pass process. The on-device voice command module can process the received voice commands to perform a generalized recognition. Audio data of the received voice commands can be sent to a server to provide a more detailed and accurate processing. The server may be better equipped (e.g., using a faster and more powerful processor) to perform voice command recognition than a mobile device. To reduce bandwidth requirements and latency issues, the audio data may not be sent to the server in its entirety. For example, the on-device voice command module can process the voice commands to identify strings of numbers, but may not be able to identify the exact voice commands. Thus, the on-device voice command module may determine that the voice commands or utterance contain “some numbers.” A larger surrounding segment of the audio data can be sent to the server, and the server can asynchronously return a much better idea of what was actually said in the voice commands. By using the server in such manner, the benefits of server processing can be obtained while reducing or minimizing the costs involved with the server processing.

The touch-screen controller 1742 can be coupled to a touch screen 1746. The touch screen 1746 and touch screen controller 1742 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 1746.

The other input controller(s) 1744 can be coupled to other input/control devices 1748, such as one or more buttons, rocker switches, thumb-wheel, infrared port, USB port, and/or a pointer device such as a stylus. The one or more buttons (not shown) can include an up/down button for volume control of the speaker 1728 and/or the microphone 1730.

In one implementation, a pressing of the button for a first duration may disengage a lock of the touch screen 1746; and a pressing of the button for a second duration that is longer than the first duration may turn power to the communications devices 115, 125, 315 and 410 on or off. The user may be able to customize a functionality of one or more of the buttons. The touch screen 1746 can, for example, also be used to implement virtual or soft buttons and/or a keyboard.

In some implementations, the communications devices 115, 125, 315 and 410 can present recorded audio and/or video files, such as MP3, AAC, and MPEG files. In some implementations, the communications devices 115, 125, 315 and 410 can include the functionality of an MP3 player.

The memory interface 1702 can be coupled to memory 1750. The memory 1750 can include high-speed random access memory and/or non-volatile memory, such as one or more magnetic disk storage devices, one or more optical storage devices, and/or flash memory (e.g., NAND, NOR). The memory 1750 can store an operating system 1752, such as Darwin, RTXC, LINUX, UNIX, OS X, WINDOWS, or an embedded operating system such as VxWorks. The operating system 1752 may include instructions for handling basic system services and for performing hardware dependent tasks. In some implementations, the operating system 1752 can be a kernel (e.g., UNIX kernel).

The memory 1750 may also store communication instructions 1754 to facilitate communicating with one or more additional devices, one or more computers and/or one or more servers. The memory 1750 may include graphical user interface instructions 1756 to facilitate graphic user interface processing; sensor processing instructions 1758 to facilitate sensor-related processing and functions; phone instructions 1760 to facilitate phone-related processes and functions; electronic messaging instructions 1762 to facilitate electronic-messaging related processes and functions; web browsing instructions 1764 to facilitate web browsing-related processes and functions; media processing instructions 1766 to facilitate media processing-related processes and functions; GPS/Navigation instructions 1768 to facilitate GPS and navigation-related processes and instructions; camera instructions 1770 to facilitate camera-related processes and functions; and voice command instructions 1772 to facilitate operation of the communications devices 115, 125, 315 and 410 as described in reference to FIGS. 1-16 above. In some implementations, the GUI instructions 1756 and/or the media processing instructions 1766 implement the features and operations described in reference to FIGS. 1-27.

The memory 1750 may also store other software instructions (not shown), such as web video instructions to facilitate web video-related processes and functions; and/or web shopping instructions to facilitate web shopping-related processes and functions. In some implementations, the media processing instructions 1766 are divided into audio processing instructions and video processing instructions to facilitate audio processing-related processes and functions and video processing-related processes and functions, respectively. An activation record and International Mobile Equipment Identity (IMEI) 1774 or similar hardware identifier can also be stored in memory 1750.

Each of the above identified instructions and applications can correspond to a set of instructions for performing one or more functions described above. These instructions need not be implemented as separate software programs, procedures, or modules. The memory 1750 can include additional instructions or fewer instructions. Furthermore, various functions of the data communications devices 115, 125, 315 and 410 may be implemented in hardware and/or in software, including in one or more signal processing and/or application specific integrated circuits.

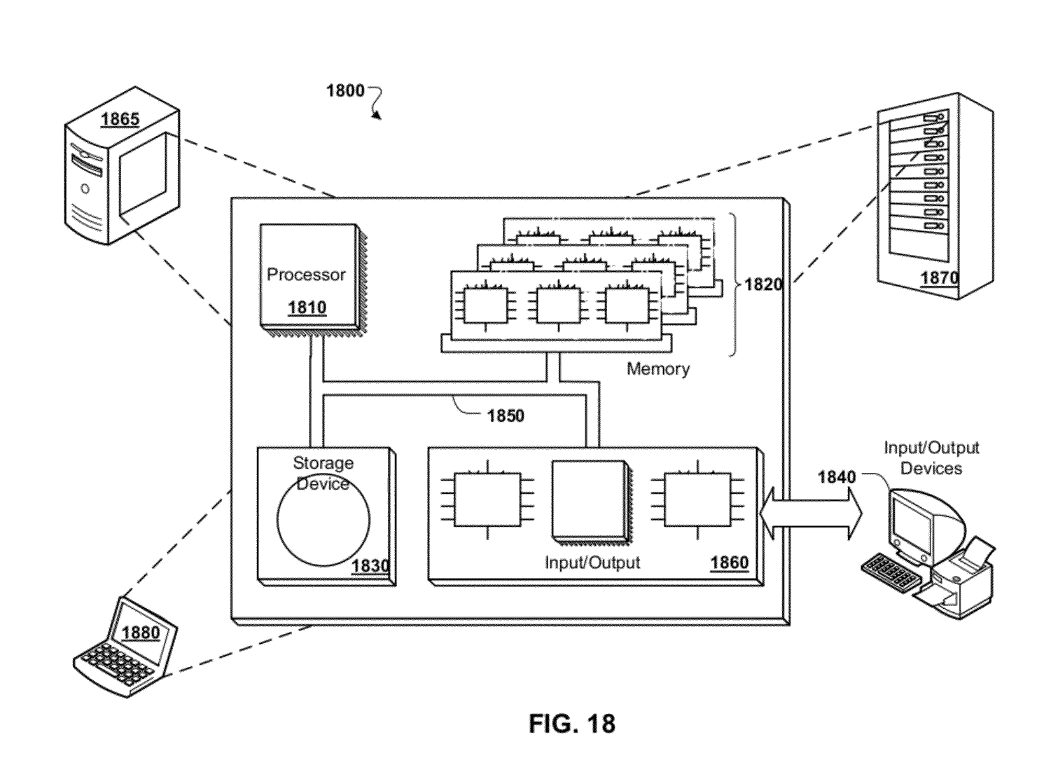

FIG. 18 is a block diagram of another computing device and system, such as the servers 105, 310 and the computing system 120 that can be used, e.g., to provide subscribers with unlimited access to media content as described with respect to FIGS. 1-16. Computing device 1800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations described and/or claimed in this document.

Computing device 1800 includes a processor 1810, memory 1820, a storage device 1830, a high-speed interface 1850 connecting to memory 1820. The computing device can also include high-speed expansion ports (not shown), and a low speed interface (not shown) connecting to low speed bus (not shown) and storage device 1830. Each of the components 1810, 1820, 1830, 1850, and 1820, are interconnected using various busses, and can be mounted on a common motherboard or in other manners as appropriate. The processor 1810 can process instructions for execution within the computing device 1800, including instructions stored in the memory 1820 or on the storage device 1830 to display graphical information for a GUI on an external input/output device, such as display 1840 coupled to an input/output interface 1860. In other implementations, multiple processors and/or multiple buses can be used, as appropriate, along with multiple memories and types of memory. Also, multiple computing devices 1800 can be connected, with each device providing portions of the necessary operations (e.g., as a server bank, a group of blade servers, or a multi-processor system).

The memory 1820 stores information within the computing device 1800. In one implementation, the memory 1820 is a computer-readable medium. In one implementation, the memory 1820 is a volatile memory unit or units. In another implementation, the memory 1820 is a non-volatile memory unit or units.

The storage device 1830 is capable of providing mass storage for the computing device 1800. In one implementation, the storage device 1830 is a computer-readable medium. In various different implementations, the storage device 1830 can be a floppy disk device, a hard disk device, an optical disk device, or a tape device, a flash memory or other similar solid state memory device, or an array of devices, including devices in a storage area network or other configurations. The computer program product contains instructions that, when executed, perform one or more methods, such as those described above. The computer- or machine-readable medium can include the memory 1820, the storage device 1830, memory on processor 1810, or a propagated signal.

The high speed controller 1850 manages bandwidth-intensive operations for the computing device 1800, while the low speed controller manages lower bandwidth-intensive operations. Such allocation of duties is exemplary only. In one implementation, the high-speed controller 1850 is coupled to memory 1820, display 1840 (e.g., through a graphics processor or accelerator), and to high-speed expansion ports (not shown), which can accept various expansion cards (not shown). In the implementation, low-speed controller (not shown) is coupled to storage device 1830 and low-speed expansion port (not shown). The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 1800 can be implemented in a number of different forms, as shown in the figure. For example, it can be implemented as a standard server 1865, or multiple times in a group of such servers. It can also be implemented as part of a rack server system 1870. In addition, it can be implemented in a personal computer such as a laptop computer 1880.

Moreover, the disclosed techniques for providing subscribers with unlimited access to media content may be implemented using one or more computer programs comprising computer executable code stored on a tangible computer readable medium and executing on the data processing device or system. The computer readable medium may include a hard disk drive, a flash memory device, a random access memory device such as DRAM and SDRAM, removable storage medium such as CD-ROM and DVD-ROM, a tape, a floppy disk, a Compact Flash memory card, a secure digital (SD) memory card, or some other storage device. In some implementations, the computer executable code may include multiple portions or modules, with each portion designed to perform a specific function described in one or more figures. In some implementations, the techniques may be implemented using hardware such as a microprocessor, a microcontroller, an embedded microcontroller with internal memory, or an erasable, programmable read only memory (EPROM) encoding computer executable instructions for performing the disclosed techniques. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory, a random access memory, or both. The elements of a computer include a processor for executing instructions and one or more memory devices for storing instructions and data. Generally, a computer will also include, or be operatively coupled to receive data from or transfer data to, or both, one or more mass storage devices for storing data, e.g., magnetic disks, magneto-optical disks, and optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, the systems, apparatus, and techniques described here can be implemented on a data processing device having a display device (e.g., an LED (light emitting diode) or LCD (liquid crystal display) monitor) for displaying information to the user and a positional input device, such as a keyboard and a pointing device (e.g., a touch screen, mouse, or trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, the separation of various system components in the embodiments described above should not be understood as requiring such separation in all embodiments.

Only a few implementations and examples are described and other implementations, enhancements and variations can be made based on what is described and illustrated in this application.

What is claimed is:

1. A computer-implemented method of providing access to media content, the method comprising:
receiving a request from a mobile communications device associated with a user to subscribe to a media playlist;
determining, for the mobile communications device, a local media archive inventory;
comparing the local media archive inventory with a track listing corresponding to the subscribed media playlist; and
modifying contents of the local media archive inventory based on the comparing.

2. The computer-implemented method of claim 1, wherein modifying the contents of the local media archive inventory based on the comparing comprises:
transferring to the mobile communications device an item of media content associated with the track listing that is not included in the local media archive inventory.

3. The computer-implemented method of claim 1, wherein modifying the contents of the local media archive inventory based on the comparing comprises:
deleting from the mobile communications device an item of media content not associated with the track listing that is included in the local media archive inventory.

4. The computer-implemented method of claim 1, further comprising maintaining the subscribed media playlist at a server configured to provide unlimited media content.

5. The computer-implemented method of claim 4, wherein maintaining the subscribed media playlist at a server comprises:
identifying another media playlist subscribed to by another user; and
modifying the media playlist subscribed to by the user based on the identified media playlist subscribed to by the other user.

6. The computer-implemented method of claim 5, wherein modifying the media playlist subscribed to by the user based on the identified media playlist subscribed to by the other user comprises:
reviewing a track listing corresponding to the other media playlist subscribed to by the other user; and
selecting one or more items of media content associated with the track listing corresponding to the other media playlist subscribed to by the user; and
modifying the track listing corresponding to the media playlist subscribed to by the user to include the selected one or more items of media content.

7. The computer-implemented method of claim 1, further comprising automatically maintaining the local media archive inventory based on the track listing corresponding to the subscribed media playlist.

8. The computer-implemented method of claim 7, wherein automatically maintaining the local media archive inventory based on the track listing corresponding to the subscribed media playlist further comprises:
detecting a change to the media playlist subscribed to by the user;
comparing the local media archive inventory with the track listing corresponding to the subscribed media playlist; and
updating contents of the local media archive inventory based on the comparing.

9. The computer-implemented method of claim 7, wherein automatically maintaining the local media archive inventory based on the track listing corresponding to the subscribed media playlist further comprises:
receiving a request from the communications device associated with the user to access the subscribed media playlist;
responsive to the received request, checking the media playlist subscribed to by the user to detect a change in the track listing;
updating contents of the local media archive inventory based on the detected change.

10. The computer-implemented method of claim 1, wherein the subscribed media playlist is associated with and subscribed to by another user.

11. The computer-implemented method of claim 10, further comprising updating the subscribed media playlist.

12. The computer-implemented method of claim 1, further comprising:
removing a connection between the local media archive inventory and the subscribed media playlist; and
controlling the local media archive inventory at the communications device independent of the subscribed media playlist.

13. The computer-implemented method of claim 1, further comprising:
receiving from the communications device, user selection of one or more items of media content to add to the subscribed media playlist; and
modifying the subscribed media playlist to add the received user selection of one or more items of media content.

14. A media server device for providing access to media content, the media server comprising a processor for performing operations comprising:
receiving a request to subscribe to a media playlist from a mobile communications device associated with a user;
determining, for the mobile communications device, a local media archive inventory;
comparing the local media archive inventory with a track listing corresponding to the subscribed media playlist; and
modifying contents of the local media archive inventory based on the comparing.

15. The media server device of claim 14, wherein modifying the contents of the local media archive inventory based on the comparing comprises:
transferring to the mobile communications device an item of media content associated with the track listing that is not included in the local media archive inventory.

16. The media server device of claim 14, wherein modifying the contents of the local media archive inventory based on the comparing comprises:
deleting from the mobile communications device an item of media content not associated with the track listing that is included in the local media archive inventory.

17. The media server device of claim 14, further comprising maintaining the subscribed media playlist at a server configured to provide unlimited media content.

18. The media server device of claim 14, wherein maintaining the subscribed media playlist at a server comprises:
identifying another media playlist subscribed to by another user; and
modifying the media playlist subscribed to by the user based on the identified media playlist subscribed to by the other user.

19. The media server device of claim 18, wherein modifying the media playlist subscribed to by the user based on the identified media playlist subscribed to by the other user comprises:
reviewing a track listing corresponding to the other media playlist subscribed to by the other user; and
selecting one or more items of media content associated with the track listing corresponding to the other media playlist subscribed to by the user; and
modifying the track listing corresponding to the media playlist subscribed to by the user to include the selected one or more items of media content.

20. The media server device of claim 14, further comprising automatically maintaining the local media archive inventory based on the track listing corresponding to the subscribed media playlist.

21. The media server device of claim 20, wherein automatically maintaining the local media archive inventory based on the track listing corresponding to the subscribed media playlist further comprises:
detecting a change to the media playlist subscribed to by the user;
comparing the local media archive inventory with the track listing corresponding to the subscribed media playlist; and
updating contents of the local media archive inventory based on the comparing.

22. The media server device of claim 20, wherein automatically maintaining the local media archive inventory based on the track listing corresponding to the subscribed media playlist further comprises:
receiving a request from the communications device associated with the user to access the subscribed media playlist;
responsive to the received request, checking the media playlist subscribed to by the user to detect a change in the track listing;
updating contents of the local media archive inventory based on the detected change.

23. The media server device of claim 14, wherein the subscribed media playlist is associated with and subscribed to by another user.

24. The media server device of claim 14, further comprising:
removing a connection between the local media archive inventory and the subscribed media playlist; and
controlling the local media archive inventory at the communications device independent of the subscribed media playlist.

25. The media server device of claim 14, further comprising:
receiving from the communications device, user selection of one or more items of media content to add to the subscribed media playlist; and
modifying the subscribed media playlist to add the received user selection of one or more items of media content.

26. A non-transitory computer-readable media embodying instructions operable to cause a data processing device to perform operations comprising:
receiving a request from a mobile communications device associated with a user to subscribe to a media playlist;
determining, for the mobile communications device, a local media archive inventory;
comparing the local media archive inventory with a track listing corresponding to the subscribed media playlist; and
modifying contents of the local media archive inventory based on the comparing.
